(19) United States
(12) Patent Application Publication
(10) Pub. No.: US 2006/0167942 A1
(43) Pub. Date: Jul. 27, 2006

(54) Enhanced client relationship management systems and methods with a recommendation engine

(76) Inventors: Scott G. Lucas, Palm Desert, CA (US); David S. Lee, Mission Viejo, CA (US); Adel M. Francis, Trabuco Canyon, CA (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 11/261,140

(22) Filed: Oct. 27, 2005

Related U.S. Application Data
(60) Provisional application No. 60/622,552, filed on Oct. 27, 2004.

(51) Int. Cl. G06F 7/00

(52) U.S. Cl. 707/104.1

(57) ABSTRACT

The present invention relates to an enhanced customer relationship management systems and methods for receiving information objects in a variety of formats from a variety of information sources and communicating the objects to contact. A CRM application may be provided for storing contact-associated information (e.g., keyphrases related to contact interests, contact holdings, etc.), user-associated information in an application database and used to search for objects in at least one information source. Objects retrieved from a search may be presented to the user according to their relevance to the search. The relevance of an object may be determined in accordance with a scoring system where objects are scored and provided in order of their score.

### CROSS-REFERENCE TO RELATED APPLICATIONS

This application claims the benefit of U.S. Provisional Application No. 60/622,552, filed Oct. 27, 2004, which is hereby incorporated herein by reference in its entirety.

### BACKGROUND OF THE INVENTION

The present invention relates to systems and methods for enhancing client relationship management (CRM) using a recommendation engine. More particularly, the present invention relates to systems and methods for allowing relationship managers to provide clients or contacts with timely and the most relevant information in a variety of formats from a variety of sources so that contacts can make better informed decisions.

One key element in a successful partnership between relationship managers and their clients is the exchange of timely and relevant communication. Traditional relationship managers include brokers, agents, sales professionals, stock brokers, financial advisors, real estate agents, travel agents, insurance agents, professionals (such as doctors and lawyers), and any person or individual who initiates contact with clients, contacts or customers. Relationship managers may be employed by a firm, such as, a brokerage firm, sales company, marketing company, financial institution, real estate agency, travel agency, insurance agency, doctor's office, law firm, or any other employer that employs relationship managers. Each of the individuals with whom a relationship manager communicates with or contacts will be referred to herein as either a client, a contact or an individual. In addition to individuals being clients of a relationship manager, the employer of these individuals may also be clients of the relationship manager. Employers of contacts will be referred to herein as accounts and accounts may include any employer that employs contacts that a relationship manager might wish to contact. The goal of a successful relationship manager is to develop and enhance relationships with clients. However, relationship managers lack the adequate tools for perpetuating new reasons to contact clients to achieve these goals.

Known CRM systems and methods currently exist that only solve the problem of organizing contact information after the relationship manager has already initiated contact with the client or potential client. For example, CRM applications are used to collect information about the client and record notes regarding prior conversations with the client. However, these applications do not adequately assist the relationship manager in making new contact with a client, which would further enhance the relationship.

One of the most significant attributes a successful relationship manager must have is the ability to stay abreast of news and information which affects their area of specialization as well as the interests of their clients. To accomplish this end, relationship managers may use a variety of tools, in addition to CRM applications, to collect and distribute information to their clients. For example, relationship managers may use web browsers with search engines, television information sources, or other tools that are separate from the CRM application for locating information that may be of interest to their clients. The relationship manager must then manually sort through vast amounts of information received from these sources to determine information that may be of interest to their clients.

The relationship manager may use communication devices, such as a telephone or electronic mail, to disseminate this information to their clients. Because so much information exists in today's information age, it is virtually impossible for a relationship manager to manually search for, retrieve, review and communicate to a client all available information that will enhance the contact's ability to make better decisions.

Commonly-assigned U.S. Pat. No. 6,732,092, issued May 4, 2004 (“the '092 patent”) and U.S. patent application Ser. No. 10/293,393, filed Nov. 12, 2002 (“the '393 application”), which are hereby incorporated by reference herein in its entireties, present various solutions to these and other problems associated with managing professional relationships. As a front-end application software database architecture and information delivery tool with a comprehensive, functional graphical user interface, the inventions disclosed in the '092 patent and the '393 application allow relationship managers (“users”) to import existing client lists, add or create client profiles, generate “to-do” lists and action items, retrieve text, web sites, articles, and documents from one or more databases, add one or more keyphrases related to contact interests to each contact profile and, optionally, add user-based keyphrases.

In addition, the inventions disclosed in the '092 patent and the '393 application allow users to perform keyphrase queries on informational databases for objects, such as articles, containing one or more keyphrases stored in an application database, and displays the retrieved results list with corresponding keyphrase, title, published date and associated clients who have profiles with matching keyphrases. The user may add retrieved articles to an action list, edit the retrieved information and edit client profiles stored in the database.

The invention disclosed in the '092 patent and the '393 application also includes point and click electronic mail functionality for retrieved objects or imported objects and also searches the body of the retrieved or imported object for keyphrases based on contact profiles and returns names of contacts who may be interested. The '092 patent and the '393 application also allow a user to import plain text or entire files from any external source, such as text from a news article, or a text document file.

The results of the keyphrase searches performed based on contact profiles identify relevant and meaningful articles or other content by filtering vast amounts of available objects. The relationship manager may review this filtered list to select objects that can serve as a contact opportunity (i.e., an article may provide a relationship manager with a reason or excuse to contact their client or potential client).

However, additional features may be implemented on the platform of the '092 patent and the '393 application to further facilitate users in developing and enhancing relationships with contacts. For example, the filtered list of objects resulting from the keyphrase search may still be extensive. It would therefore be desirable for users of a CRM application to receive the most valuable information from the extensive list of filtered objects.

### SUMMARY OF THE INVENTION

It is therefore an object of the present invention to implement a recommendation engine to filter search results and provide the search results that may aid a user in recognizing the most relevant content.

These and other objects of the present invention are accomplished in accordance with the invention by providing enhanced client relationship management systems and methods using a recommendation engine. For example, a CRM application may be provided for receiving information objects in a variety of formats from a variety of information sources. Objects may be text files, web pages, portable document format files, downloadable video and audio files, real-time streaming video broadcasts, web-based audio broadcasts, television programs, information related to products, or any other information in any available format.

Objects may be searched and retrieved based on user-associated, contact-associated, or account-associated information (e.g., keyphrases, holdings, or any other information that may be mapped to a user, account, or contact profile). Retrieved objects may then be reviewed by the user and the information may be summarized and communicated via a communication application, such as a telephone application, electronic mail application, or by any other available communication device or application (e.g., via pager, real-time videoconference, etc.).

Objects may be retrieved by a user in response to the user executing a search request for a particular account, contact or keyphrase. Objects retrieved may be ranked according to their relevancy to the user, contact, account, or keyword searched. Information may be dynamically updated periodically so that the user is informed of breaking news without having to perform a search request to receive relevant objects. Users may also be provided with an opportunity to retain, and later view, selected objects, schedule searches to occur at a particular time or frequency, and set alerts for particular information. Users and contacts may receive reminders and alerts via e-mail, telephone, wireless pager, or by any other method.

An enhanced user interface may be provided that lists accounts or contacts according to priority. The user interface may present various frames, and the user may browse the information requested using tabs identifying data silos. Data silos refer to groupings of information based on, for example, the type, source, or use of the information.

### BRIEF DESCRIPTION OF THE DRAWINGS

The above and other objects and advantages of the invention will be more apparent upon consideration of the following detailed description, taken in conjunction with the accompanying drawings, in which like reference numerals refer to like parts throughout, and in which:

FIG. 1 is a diagram of illustrative software and hardware used in accordance with certain embodiments of the present invention;

FIG. 2 is a flow diagram of a main process that may be used to provide objects using the recommendation engine in accordance with certain embodiments of the present invention;

FIGS. 3-9 show illustrative display screens for establishing user, account, and contact profiles in accordance with certain embodiments of the present invention;

FIGS. 10, 11 and 13 are tables for scoring objects in accordance with certain embodiments of the present invention;

FIG. 12 is a flow diagram of a process that may be used to score objects using the recommendation engine in accordance with certain embodiments of the present invention;

FIGS. 14-16 show illustrative display screens for presenting, providing access to and communicating to contacts objects retrieved from a search in accordance with certain embodiments of the present invention;

FIG. 17 is a cross-sectional view of a magnetic data storage medium encoded with a set of machine-executable instructions for performing the method according to the present invention; and

FIG. 18 is a cross-sectional view of an optically readable data storage medium encoded with a set of machine-executable instructions for performing the method according to the present invention.

### DETAILED DESCRIPTION

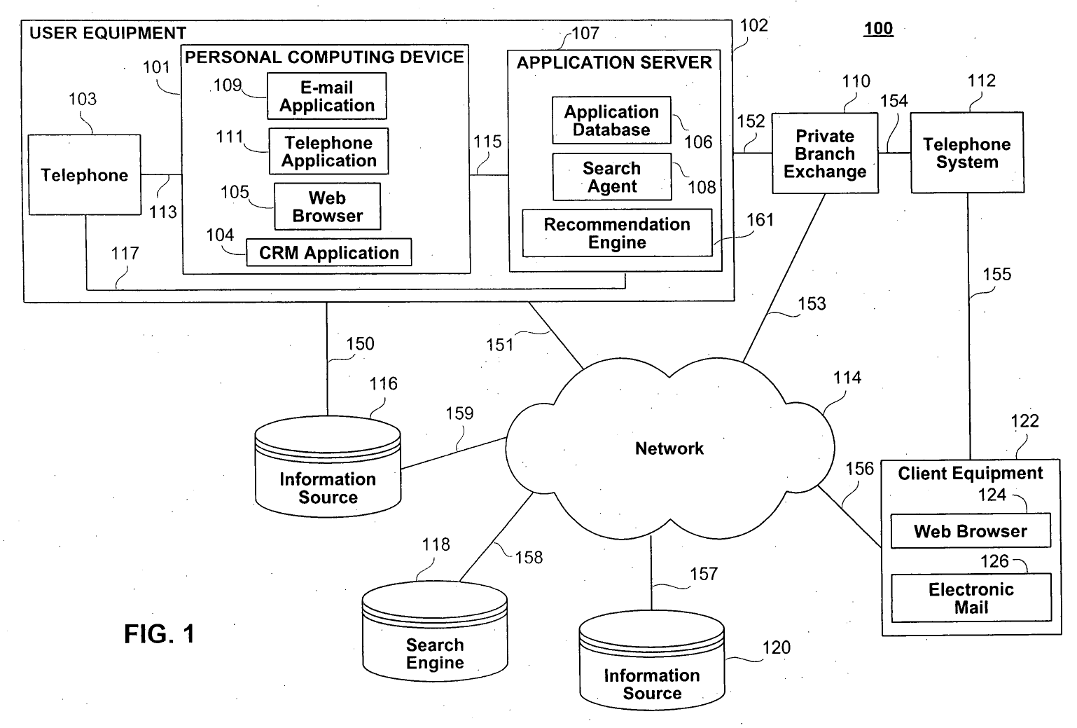

The present invention is now described in more detail in conjunction with FIGS. 1-18.

FIG. 1 is a schematic diagram 100 of illustrative software and hardware that may be used to implement the systems and methods of the present invention. In FIG. 1, the relationship manager (“user”) may operate user equipment 102, which may include, for example, personal computing device 101, telephone 103, application server 107, any other suitable device or devices, or a combination thereof. Personal computing device 101 may be a personal computer (e.g., an IBM-compatible PC, an apple computer, etc.), a handheld computing device (e.g., a personal digital assistant), a wireless computing device, or any other suitable computing device. Telephone 103 may be any suitable wired or wireless telephone based on a telephone network. Application server 107 may be, for example, a web server, an enterprise server, a mainframe computer, any other suitable computing device or devices, or a combination thereof. Other hardware components of user equipment 102 and combinations of hardware components may also exist. For example, user equipment 102 may include two types of a personal computing device 101 (e.g., a personal computer and a personal digital assistant). However, for brevity and clarity, only personal computing device 101, telephone 103, and application server 107 are shown. It will be better understood that there may be numerous user equipment 102 (including each of the devices included therein), but for brevity and clarity, only user equipment 102 is shown.

The devices comprising user equipment 102 may include appropriate hardware (e.g., circuits, processors, memory, user input devices, display devices, etc.) needed for implementing algorithms or software applications, for example, CRM application 104, recommendation engine 161, web browser 105, e-mail application 109, telephone application 111, search agent 108, or any other suitable algorithm or software application.

Search agent 108 may include any conventional search algorithm for searching a database of information using search parameters (e.g., keyphrases) and may be implemented by application server 107 or any other suitable device included in user equipment 102. Recommendation engine 161 may be included as part of search agent 108 or may be a stand alone application. Recommendation engine 161 may optimize the results of the searches performed by search agent 108. Recommendation engine 161 may be implemented by application server 107 or any other suitable device included in user equipment 102.

Application database 106 may also be implemented by application server 107 or by any other suitable device included in user equipment 102. Application database 106 may be, for example, any number of multi-tiered databases for storing information such as information related to user profiles, account profiles, contact profiles, and any other relevant information, including recommendation engine information. User profiles may include, for example, a list of accounts, a list of contacts, user personal information, keyphrases associated with a user's interest or specialty, or any other available information. Account profiles may include a list of contacts in an account, account specific information, keyphrases related to account interests, a list of account holdings, links to contact profiles that are part of the account, or any other suitable information. Contact profiles may include information related to a contact's personal information, keyphrases related to contact interests, a list of contact holdings, or any other suitable information. Recommendation engine information will be discussed in greater detail below, but may include information helpful in optimizing search results, such as, ranking information which may include scoring information, scoring tables, scoring formula information, and any other relevant information to optimize search results. The ranking information will be dicussed in more detail below. The information in application database 106 may be in any suitable data management format, environment, or application, for example, a relational database format, an object oriented database format, a data warehouse, a data directory, a knowledge management system, or any other suitable device, environment or application for storing and indexing related information.

In FIG. 1, CRM application 104, web browser 105, e-mail application 109, and telephone application 111 are each implemented by personal computing device 101 while application database 106, search agent 108, and recommendation engine 161 are implemented by application server 107. It will be understood, however, that the software applications used in connection with the present invention may be implemented by any device included as part of user equipment 102 and that the single embodiment of FIG. 1 is used merely as an illustration. For example, in one embodiment, such as the case of a perfectly distributed network (e.g., thin-contact computing, application service provider, etc.), all software applications may be implemented by application server 107, while personal computing device may only include a user interface. In another embodiment telephone application 111 and any other suitable software application (e.g., e-mail application 109, web browser 105, etc.) may be implemented by telephone 103, for example if telephone 103 is a web-enabled telephone capable of web browsing as well as conventional telephone functions.

The components of user equipment 102 may be located adjacent to one another (as shown) or remote from one another. For example, application server 107 may be located at a site remote for personal computing device 101 and telephone 103, and may be accessed using network 114, which may be any local or wide area network. Personal computing device 101, telephone 103, and application server 107 may communicate via communication paths 113, 115 and 117, which may be any suitable wired or wireless communications path. For example, if wire-based, communication paths 113, 115 and 117 may be serial connections, parallel connections, telephone cables, copper wire, electric cable, fiber optic cable, coaxial cable, Ethernet cable, USB cable, FireWire cable, component video cables, composite cables, any other suitable wire-based communications path, or any combination thereof. If wireless, any suitable communications protocol or standard such as IEEE 802.11, wireless application protocol (WAP), radio frequency (RF), Bluetooth, (Extended) time division multiple access (TDMA), code-division multiple access (CDMA), global systems for mobile communications (GSM), or any other suitable wireless communications path or protocol may be used. A combination of wired and wireless communication paths may also be used.

User equipment 102 may be coupled to network 114 via communications path 151. Network 114 may be a local or wide area network (e.g., the Internet, an intranet, etc.) and may support any combination of wired, wireless, or optical communications. Information may be provided to user equipment 102 from various information sources and search engines 116, 118, and 120 which may be coupled to network 114 via communications paths 159, 158, and 157, respectively. Information sources may also be directly coupled to user equipment 102 without network 114, for example via communications path 150 providing a dedicated communications link between information source 116 and user equipment 102. It will be understood that many instances and types of information sources and search engines may be coupled to network 114. However, for brevity and clarity only several are shown in FIG. 1.

User equipment 102 may be coupled to private branch exchange (PBX) 110 via communications path 152. It will be understood that PBX 110 may be any telephone communication system capable of placing telephone calls from a user to a contact. For the purposes of brevity and clarity, only PBX 110 is shown in FIG. 1. In embodiments where user equipment is part of a corporate communications infrastructure, numerous PBX servers may be used. In other embodiments of the present invention, for example in the case of a self-employed relationship manager, a PBX server may not be necessary and the user may communicate with the contact directly using a conventional telephone system (e.g., telephone system 112 which may include a Public Switched Telephone Network (PSTN), a cellular network, a satellite telephone systems, etc.).

PBX 110 may generate analog or digital audio signals. Analog audio signals may be communicated to telephone system 112 via communications path 154. It will be understood that telephone system 112 may be any available combination of wire-based and wireless communications systems capable of supporting analog communication signals (e.g., a PSTN or any other suitable network). However, for clarity and brevity, only telephone system 112 is shown in FIG. 1. Digital audio signals generated by PBX 110 may be communicated to network 114 via communications path 153. Digital audio signals may also be generated by user equipment 102 and communicated to network 114 via communications path 151. Network 114 may support an Internet Protocol (IP) capable of supporting voice-data in a digital format (e.g., voice-over-IP using discreet data packets).

Digital audio signals communicated from telephone system 112 via communications path 155 or from network 114 via communications path 156 may be received by client equipment 122. Client equipment 122 may include a personal computing device, a handheld computing device, a wireless computing device, a wired or wireless telephone, a web-enabled telephone, or any other device or combination of devices. Client equipment may include communication applications such as web browser 124, electronic mail 126, or any other suitable computing or communications device or application (e.g., a telephone, a telephone application, etc.). It will be understood that some embodiments of the present invention may include several instances of client equipment 122, used respectively by each of several contacts. However, for the purposes of clarity and brevity, only one instance of client equipment 122 is shown.

Communications paths 150-159 may be any suitable wired or wireless communications path. For example, if wire-based, communications paths 150-159 may be serial connections, parallel connections, telephone cables, copper wire, electric cable, fiber optic cable, coaxial cable, Ethernet cable, USB cable, FireWire cable, component video cables, composite cables, any other suitable wire-based communications path, or any combination thereof. If wireless, any suitable communications protocol or standard such as IEEE 802.11, wireless application protocol (WAP), radio frequency (RF), Bluetooth, (Extended) time division multiple access (TDMA), code-division multiple access (CDMA), global systems for mobile communications (GSM), or any other suitable wireless communications path or protocol may be used. A combination of wired and wireless communication paths may also be used. Communications paths 151, 153, and 156-159 may provide access to network 114 via a web server, a network gateway, any other suitable device, or a combination thereof.

A communication application such as telephone application 111 implemented on user equipment 102 may be used in conjunction with the CRM application to provide a user with an opportunity to call a contact. Telephone applications are widely available that allow users to communicate between two personal computing devices, between a personal computing device and a telephone, between two telephones, or by way of other suitable communication devices. Telephone applications may use various networks and support various protocols to allow communication between devices. For example, communication between devices may occur over the Internet (using an Internet protocol that supports the transmission of voice data), over a PSTN, via a private branch exchange, or by any other suitable method.

Telephone application 111 may provide a user at user equipment 102 with an opportunity to place a telephone call to a contact at client equipment 122. Upon receiving indication from the user to call the contact, the telephone application may retrieve the contact's telephone number from application database 106 and automatically dial the contact's telephone number. Systems and methods for placing telephone calls in accordance with the telephone application and the CRM application are described in greater detail in the '393 application.

The software and hardware illustrated in FIG. 1 may be used to implement the systems and methods of the present invention. For example, a user may operate user equipment 102 to access CRM application 104 for creating user profiles having user-associated information, account profiles having account-associated information, or contact profiles having contact-associated information. Because more than one user may be provided access to the CRM application, it may be necessary to provide each user with a distinct profile to distinguish between users. User profiles may include user-associated information such as a list of accounts, a list of contacts, user personal information, keyphrases associated with a user's interest or specialty, or any other suitable information. Using CRM application 104, each user may create account profiles having account-associated information, which may include account specific information, keyphrases related to account interests, a list of account holdings, links to contact profiles that are part of an account, or any other suitable information. Using CRM application 104, each user may also create contact profiles having contact-associated information, which may include personal information, keyphrases related to a contact's interests, a list of contact financial holdings, or any other suitable information. User profiles, account profiles, and contact profiles may also be created by a system administrator operating user equipment 102. User profiles and contact profiles and all associated information may be stored in application database 106.

Information stored in external information sources 116, 118, and 120 may be accessed by user equipment 102, and users may search the information and retrieve objects using user-associated information from user profiles (e.g., user keyphrases), account-associated information from account profiles (e.g., keyphrases related to an account's interests, account holdings, etc.), or contact-associated information from contact profiles (e.g., keyphrases related to a contact's interests, contact holdings, etc.). Objects may include various types of information (e.g., news articles, streaming media, information related to products, television program information, information related to a conference call, a securities exchange commission (SEC) filing, etc.) in any available format, for example, text files, web pages, portable document format files, downloadable video and audio files, real-time streaming videos broadcasts, web-based audio broadcasts, or any other suitable available information format.

The CRM application may identify objects retrieved from a search as being related to a particular user, account, or contact by matching the object's text, metadata, or other information associated with the object, to information (e.g., keyphrases and other search parameters) associated with the user, account, or contact. Objects identified as being related to the user, account, or contact may be displayed to the user, and the user may select objects to review. Once an object has been identified as related to a user, account, or contact, the object may be searched using information associated with other users, accounts, or contacts to determine if further relations exist between the selected object, users, accounts, and contacts. Systems and methods for searching information sources using user-associated, account-associated, and contact-associated information is described in greater detail in the '092 patent.

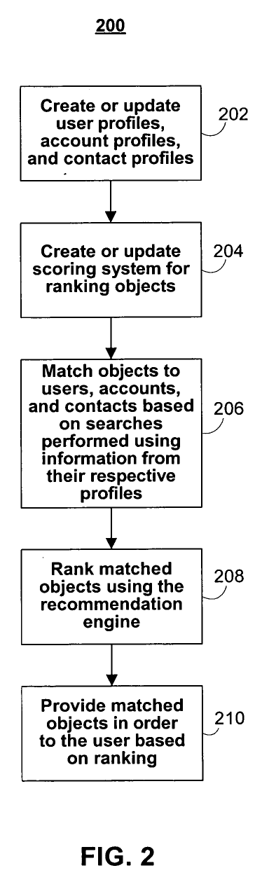

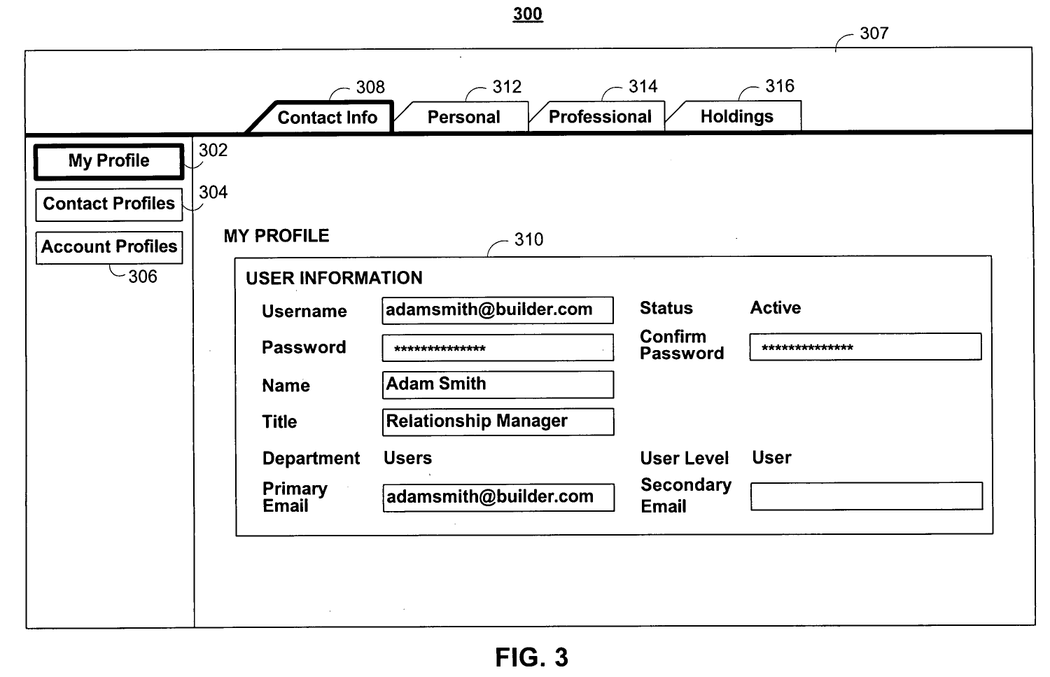

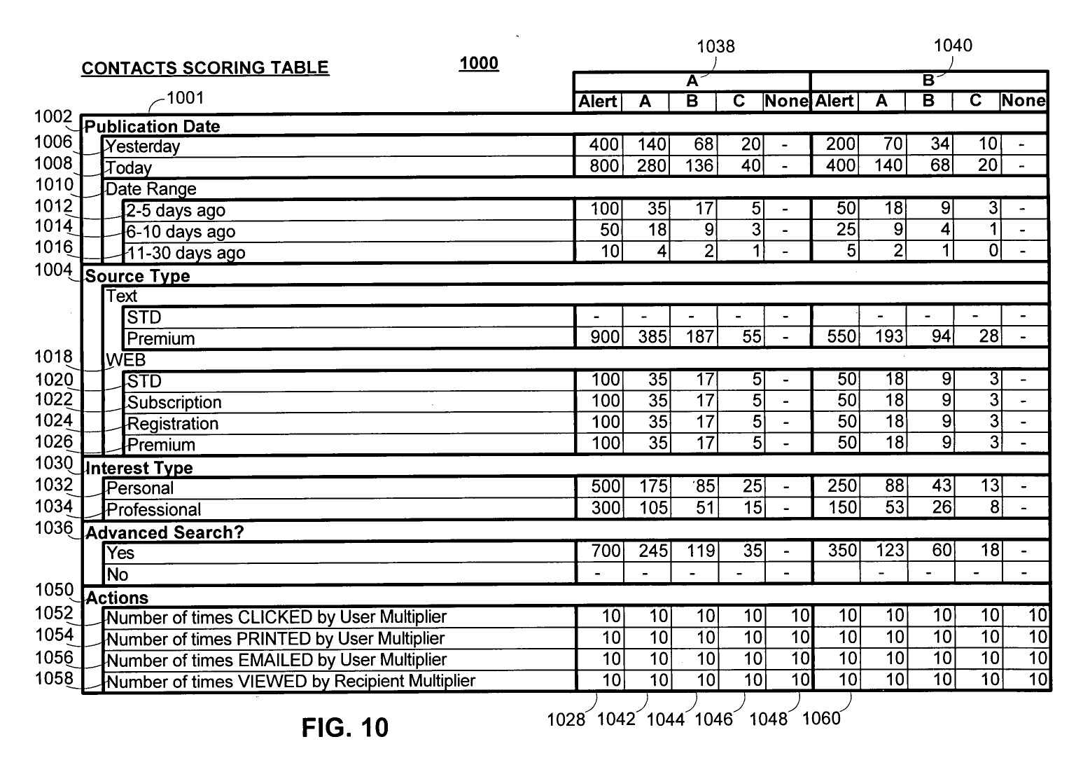

One embodiment of a process to provide objects that may be used in accordance with the principles of the present invention is illustrated in process 200 of FIG. 2. At step 202 user profiles, account profiles, and contact profiles may be created or updated. Systems and methods for creating and updating profiles are discussed in greater detail in the '092 patent, the '393 application, and below in connection with, for example, FIGS. 3-9. At step 204 a scoring system for ranking the relevance of matched objects may be created/established or updated. The establishment, creation, or updating of the scoring system may require providing certain information or establishing certain criteria by which the recommendation engine may rank objects in order of relevance. The scoring system is described in greater detail below, for example, in connection with FIGS. 10-13. The objects are matched to users, accounts, and contacts based on searches performed using information from the user profiles, account profiles, and contact profiles, respectively, at step 206. Systems and methods for searching for and matching objects are discussed in more detail below and in the '092 patent and the '393 application, which are incorporated by reference herein. At step 208, the matched objects are ranked based on relevance for users, accounts, and contacts.

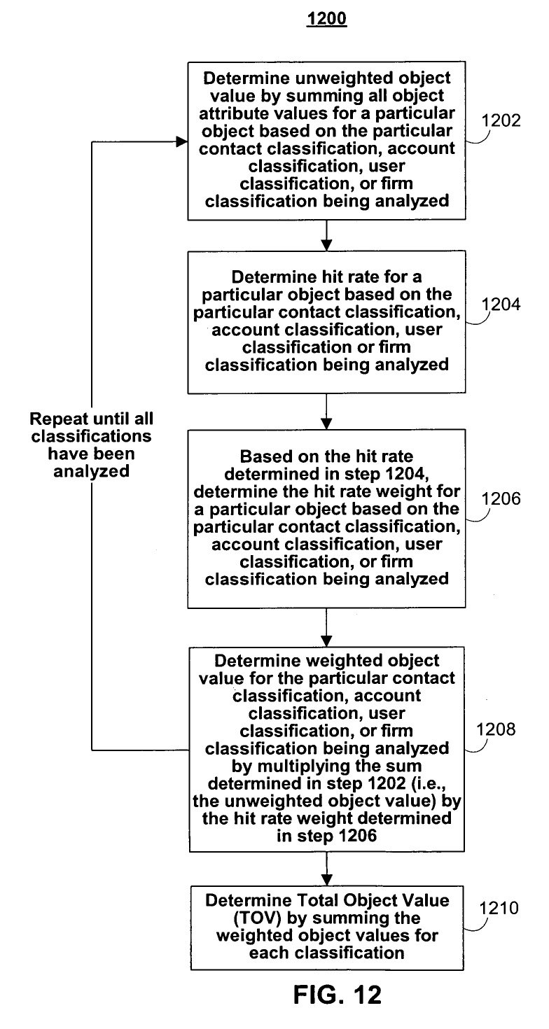

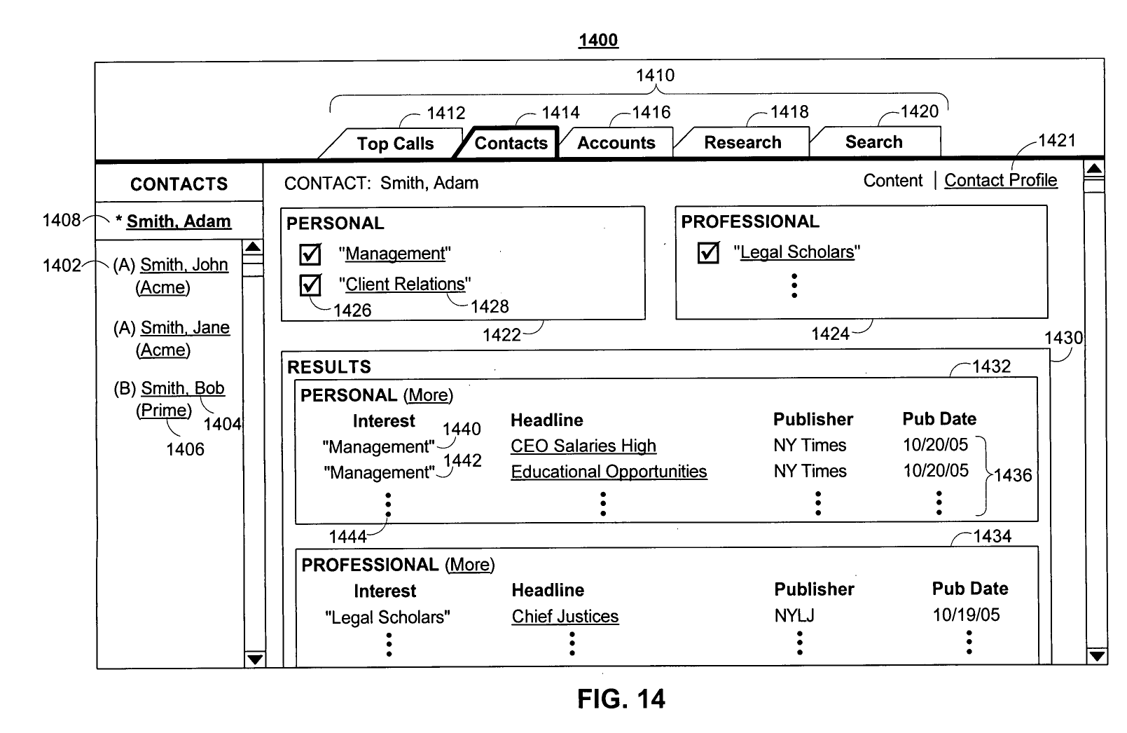

Matched objects may be ranked based on user, account, and contact profiles of step 202 and the scoring system of step 204, to provide users, contacts, and accounts with the most relevant objects. The ranking of objects may be performed in accordance with the process described below in connection with, for example, FIGS. 12 and 14-16. The ranking may be performed by recommendation engine 101 either as a stand-alone application, as integrated with search agent 108, as integrated with CRM application 104, or as integrated in any other application. For illustration of the present invention, the ranking of matched objects will be discussed as being performed by the recommendation engine herein, but this is not meant to limit the invention. Other embodiments, such as, using an integrated recommendation engine may also be utilized. The matched objects may then be provided to the user in accordance with the objects' ranking at step 210. Systems and methods for providing matched objects in accordance with their ranking is discussed below in, for example, FIGS. 14-16.

In practice, one or more steps shown in process 200 may be combined with other steps, performed in any suitable order, performed in parallel—e.g., simultaneously or substantially simultaneously—or deleted. For example, in one embodiment, step 204 may be performed prior to step 202. In fact, establishing and updating profiles (step 202) may occur at any point in process 200. Updating of the scoring system for ranking objects (step 204) may occur at any point in process 200. These updates may be performed by a system administrator to enable the recommendation engine to provide relevant objects to users more precisely.

In a further embodiment, step 206 may be deleted and all objects available (i.e., not just matched objects) may be ranked by the recommendation engine at step 208. In this embodiment, all objects may then provided to the user in order of their ranking at step 210.

FIGS. 3-9 show illustrative screen shots that may be used to implement the systems and methods of the present invention. These illustrative display screens provide a user with an opportunity to add or update user, contact, and account profiles. Profiles store various information (including keyphrases) and searching preferences for a user, account or contact). FIG. 3 shows illustrative display screen 300 which allows a user to update the user's profile. Display screen 300 includes my profile selectable option 302, which is highlighted with a dark line surrounding the option to indicate that it is currently selected. Contact profiles selectable option 304 is surrounded by a regular line indicating that it is not currently selected or highlighted. Similarly, account profiles selectable option 306 is not highlighted indicating that this option is also not currently selected. In a preferred embodiment, only one of my profile selectable option 302, contact profiles selectable option 304, and account profiles selectable option 306 may be highlighted with a dark line indicating that it is selected. When one of these options is selected, a corresponding display screen may be displayed allowing the user to update a profile or profiles associated with that option.

In one embodiment, when option 302 is selected, contact info tab 308 may initially be selected in selectable tabs region 307 and a user may update the user's contact information, password, e-mail settings, and any other desired setting of a user's profile. Updates to these settings may be accomplished by changing or adding information in various input fields. For example, user information region 310 shows that a user may update the user's username, password, name listed, title, primary, and secondary e-mail addresses. Other information not shown may also be updated including, for example, a user's address, phone number, and any other contact information.

Display screen 300 also may include other selectable tabs in tabs region 307, such as, personal interests tab 312, professional interests tab 314, and holdings tab 316. Tabs region 307 may provide these and other selectable tabs to allow a user to update a user's profile. The selectable tabs may provide the categories of information for a user's profile. After information is inputted into any of the display screens associated with these tabs, the user may save the information inputted to user's profile on, for example, database 106. The user's profile may be stored on database 106 in a manner such that the information is stored in accordance with the categories of information. As will be appreciated, the information for accounts and contacts profiles, which are described below, may also be stored on database 106 in accordance with their associated categories of information. As an example, if a user enters keyphrases as part of the user's profile in personal interest tab 314, the user profile's may be stored on the database such that the keyphrase is associated with the user's personal interests.

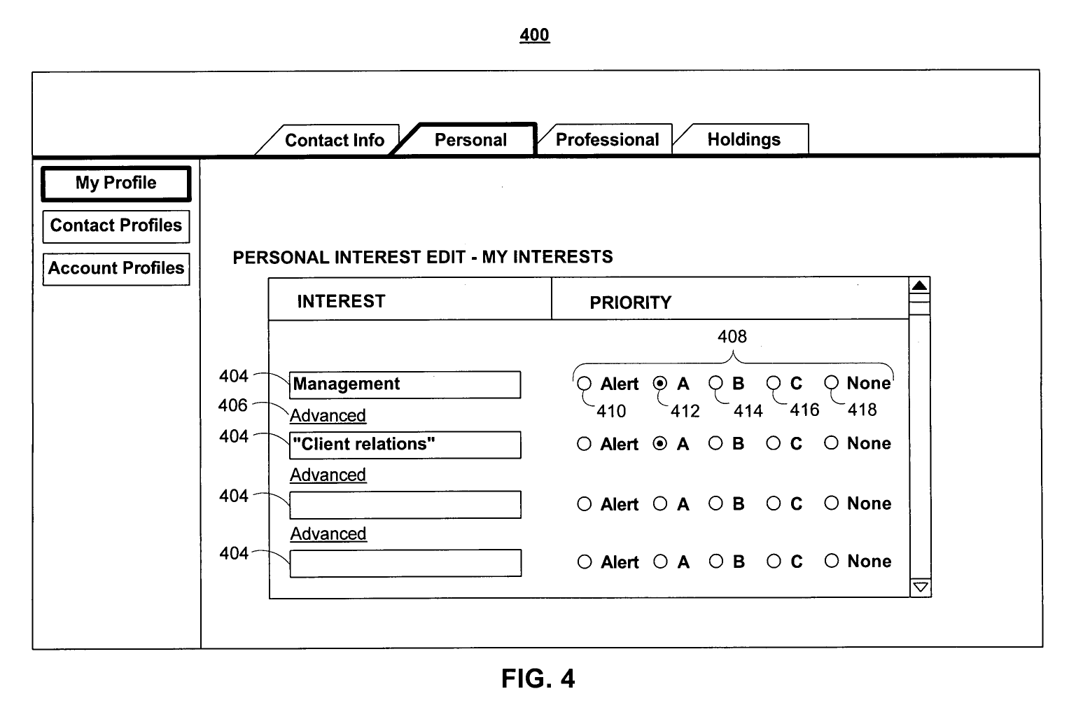

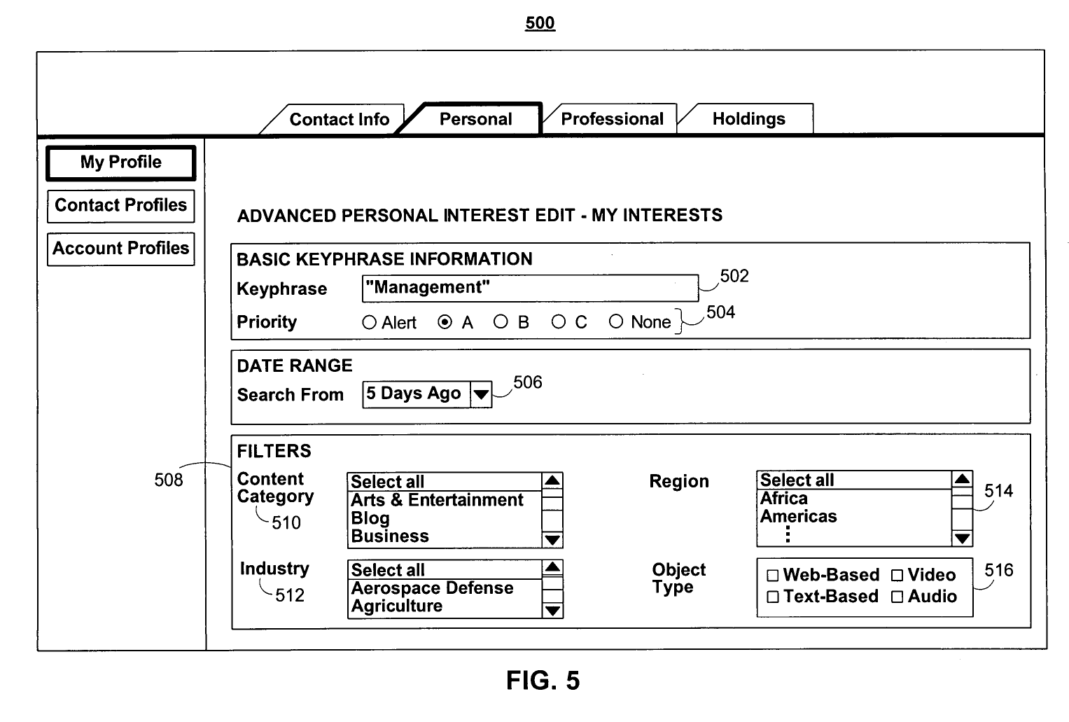

If personal interests tab 312 is selected by the user, display screen 400 of FIG. 4 may be displayed. Display screen 400 may allow the user to update the user's personal interests in the user's profile. The personal interests of a user may be encapsulated by keyphrases and other information. The CRM application may perform keyphrase searches for relevant objects based on personal interest information in the user's profile. Keyphrase input fields 404 allow for a user to enter search terms or queries. In any one of keyphrase input fields (e.g., input field 404), a user may enter standard queries or more complex queries, as desired. If a user selects advanced query selectable option 406, advanced query display screen 500 of FIG. 5 may be displayed. As will be described below, display screen 500 allows the user to specify a more detailed query.

For each input field 404, a corresponding priority selection 408 may be provided. Priority selection 408 includes five options: alert option 410, “A” option 412, “B” option 414, “C” option 416 and none option 418. Alert option 410 indicates the highest priority, with A option 412 indicating the next highest priority, continuing down to none option 418, which has the lowest priority. While priority selection option 408 in display screen 400 includes five options, the present invention is not limited to these five options. Rather, this embodiment with five options is merely provided for illustration and is not meant to limit the invention. The invention may have any number of options or may provide keyphrase priority options in other manners. For example, users may input numbers between one (1) and one-hundred (100) or any other numbering or lettering scheme to indicate a priority for keyphrases. The CRM application may also allow a user to place keyphrases in order of priority.

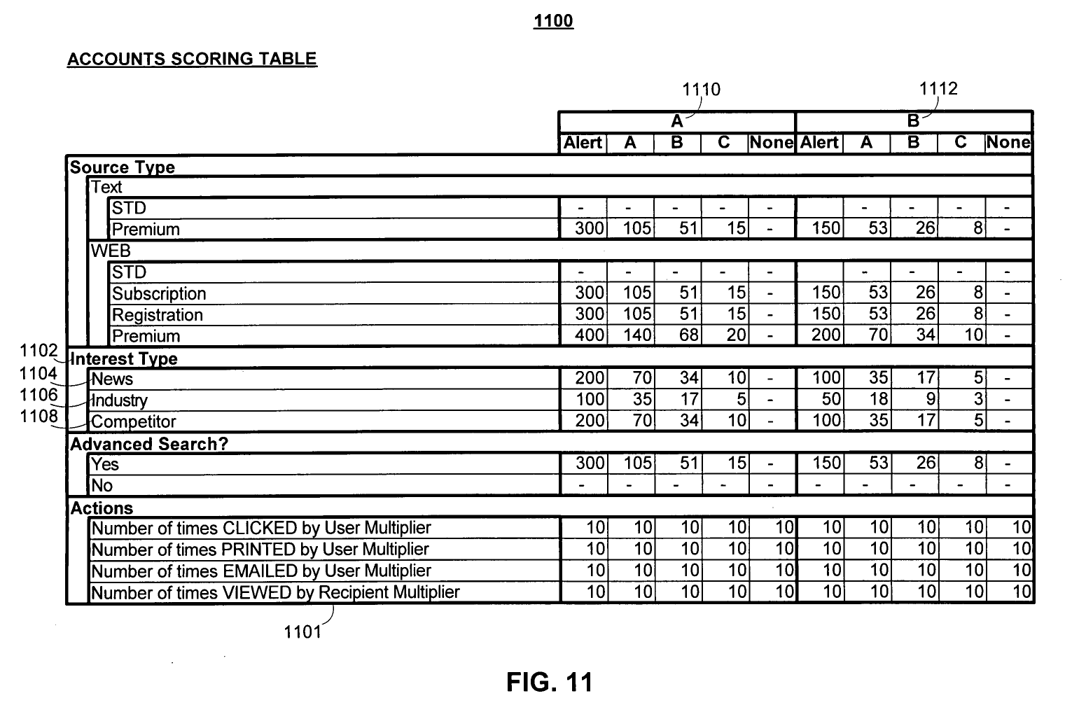

Regardless of the manner in which the priority selection for keyphrases is implemented, the priority selection may indicate the interest level for a user in that keyphrase. As will be described below, users may input keyphrases in user contacts' and accounts' profiles. The priority selection made by a user for keyphrases in these profiles indicates a user's indication, belief, or understanding of the accounts or contacts, level of interest in the topic associated with the keyphrase. The CRM application may use this priority information when evaluating objects and ranking their relevance for a user, account, or contact. The use of the priority selections as it relates to ranking objects matched to users, contacts, and accounts will be described in further detail below in connection with FIGS. 10-11.

FIG. 5 shows illustrative advanced search display screen 500 which may allow a user to specify a more detailed or advanced query. Display screen 500 may include keyphrase input field 502 and priority selection option 504, which may allow for similar input as in keyphrase input field 404 and priority selection option 408 of display screen 400 of FIG. 4. Display screen 500 may also include date range option 506 allowing a user to input a preferred or required (depending on which is desired) range in which an object was posted, published, aired, etc. that is associated with the keyphrase in input field 502. The range that may be inputted using date range option 506 may be the current day, an amount of days in the past (e.g., one day, five days, 7 days, 15 days, 30 days, etc.), an amount of months or years in the past, a range between two dates (e.g., between Nov. 5, 2004 and Nov. 12, 2004), any recurring days of a week, month or year and/or any other date range possibilities.

Display screen 500 may also include various other search filters to refine the query as provided in filters region 508. Filters region 508 may include content category filter 510, industry filter 512, region filter 514, and object type filter 516. These filters are provided merely for illustration of one embodiment of the invention and are not meant to limit the invention. Other filters may be included in other embodiments of the invention. Filters provide a user with an opportunity to further narrow a search based on a keyphrase. The filters, including the date range filter, may either be required aspects of the query or may be used to indicate preferences amongst objects that match a particular keyphrase.

Content category filter 510 may allow a user to select one or more categories of the content associated with an object, such as, arts & entertainment, blog, business, engineering, government, leisure, miscellaneous, news, organization, sports, or any other relevant categories to describe objects. Industry filter 512 may allow a user to select one or more industries an object is associated with, such as, aerospace defense, agriculture, automobiles, energy, insurance, or any other relevant industries. Region filter 514 may allow a user to select one or more geographical regions the content of an object is referencing, the geographical region an object is published from, or any other geographical component of an object. Options available in region filter 514 can include the various continents, states within the United States, provinces within another country, or any other regional classification. Object type filter 516 may allow a user to select one or more media types that a user may search, such as web-based content, text-based content, video content (e.g., television shows), audio content (e.g., radio), or any other type of content. The information described above with respect to filters may be searched by examining the metadata or other information associated with each object to determine if the information matches the object.

It will be appreciated that the description for entering information in accordance with FIGS. 4 and 5 will apply equally to other interests in a user's profile, contact's profile, or account's profile. For example, referring back to FIG. 3, upon user selection of professional interests tab 314 from display screen 300, a user may be provided a display screen to update the user's professional interests. The display screen provided may be similar to display screen 400 but it may allow a user to enter keyphrases and other information relating to the user's professional interests. The keyphrases and other information entered when professional interests tab 314 is selected are associated with user's professional interests in the user's profile.

Complex queries may also be entered directly in keyphrase input fields (e.g., keyphrase input field 404). Complex queries may be any type of command line search syntax including, for example, Boolean logic (e.g., AND, OR, NOT, etc,), quotations for phrase searches, wild card searches, or various other syntax to search specific fields within the metadata of an object (e.g., date, authors, title of object, type of object, or any other field including fields described in filters region 508).

In FIG. 3, upon selection of holdings tab 316 from display screen 300, a user may be provided with a list of the user's financial holdings and a list of financial holdings in which the user has interest. The user may also update the lists of holdings while holdings tab 316 is selected. Similar options regarding indicating priority of holding and more advanced search features may also be provided when holding tab 316 is selected. The CRM application may use the list of financial holdings to search for relevant objects. The holdings and other information entered when holdings tab is selected are associated with the user's holdings in the user's profile.

Personal interests tab 312, professional interests tab 314, and holdings tab 316 are merely exemplary tabs providing categorization of information relevant for a user for illustration of the invention. The categories of relevant information may include none, one, or more of these categories and these categories are not intended to limit the invention. In other embodiments, any other categorization of information relevant for a user may be also used. For example, if a user advises contacts in two different industries (e.g., finance and law) the user may desire to categorize information using a finance tab and law tab. The customization of these tabs may be determined by a system administrator or the CRM application may allow a user to customize information categorization tabs.

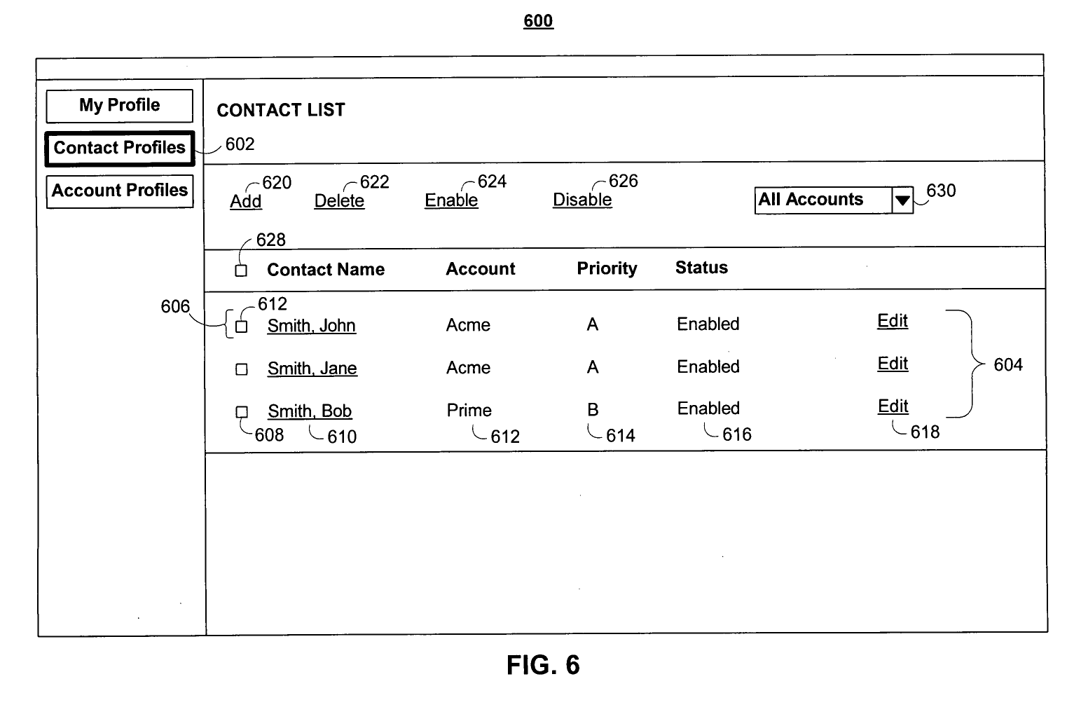

FIG. 6 shows illustrative display screen 600 which allows a user to view a list of contacts associated with the user. In display screen 600, contact profiles selectable option 602 is highlighted to indicate that it is currently selected. List 604 includes the contacts associated with the currently logged-in user. Each entry 606 may include the following fields associated with the entry: entry checkbox 608, contact name 610, account 612, priority 614, status 616, and edit option 618. Entry checkbox 608 may allow a user to select a particular contact and perform various operations for its corresponding entry (described below). Contact name 610 includes the name of a contact. Contact name 610 may be selectable for each entry enabling access to the contact's profile for viewing or editing. Account 612 indicates the account, company or other affiliation with which the particular contact is associated. Priority 614 indicates a priority level for either the contact or the account associated with the contact which indicates the level of importance for that contact or account to the user. Status 616 indicates whether searches are enabled or disabled (i.e., whether searches are being performed) for a particular contact. Edit option 618 is associated with a particular entry for a contact and enables access to the contact's profile for editing.

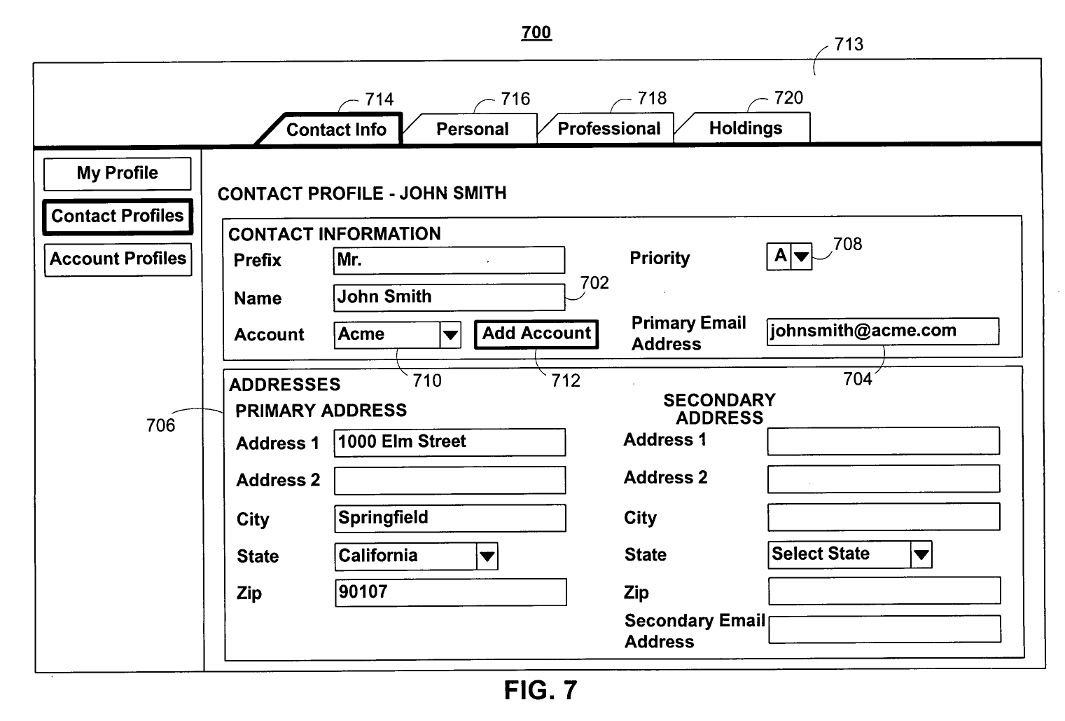

Display screen 600 may include additional selectable options, such as, add contact option 620, delete option 622, enable option 624, and disable option 626. Selecting add contact option 620 allows a user to add a contact. Further details regarding adding contacts are provided below, for example, in connection with FIG. 7. After selecting one or more of entry checkboxes 608 associated with each entry, the user may select delete option 622, enable option 624, or disable option 626. In addition, the user may select select all option 628 to select all entry checkboxes 608 in list 604. In response to selecting delete option 622, all contacts selected may be deleted. In response to selecting enable option 624, all searches for selected contacts are enabled to be performed. In response to selecting disable option 626, all searches for selected contacts are disabled from being performed. Display screen 600 may also include account viewer option 630 which may allow a user to select which contacts from a selected account a user would like to view. For example, in display screen 600, if a user selected “Acme,, from option 630, only John Smith and Jane Smith's entries would be displayed since Bob Smith is associated with the “Prime” account.

If contact name 610 or edit option 604 is selected for a particular entry, display screen 700 of FIG. 7 may be displayed allowing a user to edit a contact's profile. Display screen 700 is similar to display screen 300 of FIG. 3 which allowed a user to edit the user's contact info. When a user accesses display screen 700, contact info tab 714 is selected indicating that a user may edit various contact information, such as, name 702, e-mail address 704, addresses 706, phone numbers, and any other relevant contact information. A separate text field may also be provided enabling a user to associate notes with a particular contact (not shown). Priority option 708 allows a user to indicate a priority level or a classification for the contact. Priority option 708 may include options for selection of numbered levels one (1) through “n” where “n” is any number greater than one (1). Alternatively, lettered levels “A” through “n” may be options for selection from priority option 708 where “n” is any letter past “B” in the alphabet. Any other priority level ranking or designation system may also be used. With the priority designations, the number one (1) and the letter “A” may indicate the highest priority or lowest priority. In another embodiment, priority option 708 may be associated with the account with which a contact is associated.

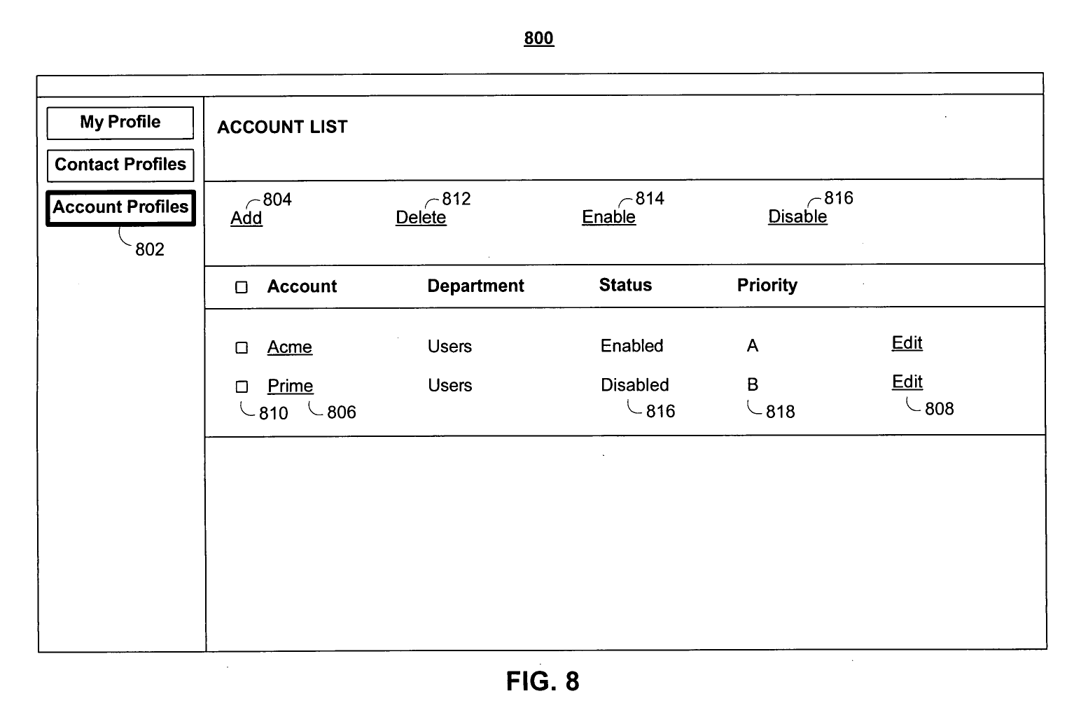

Account selectable option 710 may allow a user to select an account with which to associate a contact. If a contact is associated with an account not available through account selectable option 710, a user may select add account option 712 which allows a user create a new account (described below in connection with FIG. 8).

Display screen 700 may also include categorization tabs, such as, personal interests tab 716, professional interests tab 718, and holdings tab 720 in tabs region 713. A further description of categories is discussed hereinabove in connection with tabs region 307 of FIG. 3 and applies equally to tabs region 713. Similar to the FIG. 3, the tabs provided in FIG. 7 are provided merely for illustration and are not intended to limit the invention. If a user selects personal interests tab 716, a display screen may be provided allowing a user to update the selected contact's personal interests. The display screen provided may be similar to display screen 400 except that the display screen that is provided in response to selecting personal interests tab 716 may allow a user to enter various keyphrases and other information relating to a user's contact's personal interests. The user may also select professional interests tab 718 which may allow the user to enter keyphrases and other information associated with the selected contact's professional interests. Upon selection of holdings tab 720 from display screen 700, a user may be provided with a list of the contact's financial holdings and a list of financial holdings in which the contact has interest. The user may also update the lists of holdings while holdings tab 720 is selected. Similar options regarding indicating priority of holding and more advanced search features may also be provided when holdings tab 720 is selected. The CRM application will use the list of financial holdings (both those held by the contact and those of interest to the contact) to search for relevant objects. The holdings and other information entered when holdings tab is selected are associated with the contact's holdings in the contact's profile.

FIG. 8 shows illustrative display screen 800 which allows a user to view a list of accounts associated with the user. Display screen 800 may be accessed by selecting account profiles option 802. Account profiles option 802 is highlighted to indicate that it is currently selected. From display screen 800, a user can add an account by selecting add option 804, and update or edit an account by selecting account name option 806 or edit option 808. A user may delete, enable, or disable one or more accounts by selecting account checkbox 810 and then delete option 812, enable option 814, or disable option 816, respectively. Each account entry may also include status 816 and priority 818. The account's status and priority may have a similar relationship to the entry's account as the status and priority have to contacts, as described above in connection with FIG. 6.

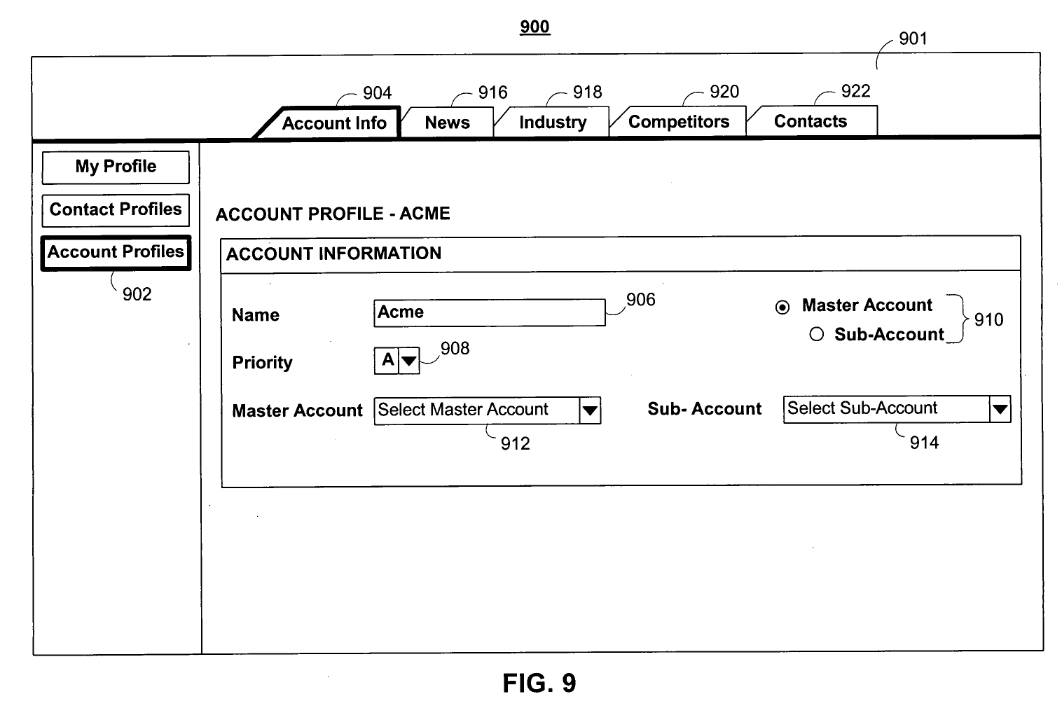

If account name option 806 or edit option 808 is selected for a particular account entry, display screen 900 of FIG. 9 may be displayed allowing a user to edit an account's profile. When a user enters display screen 900, account info tab 904 in tabs region 901 is selected indicating that a user may edit various account information. Account information may include account name 906 and account priority option 908. Account priority option 908 allows a user to indicate a priority level for the account. The priority level scheme for priority option 908 may be similar to priority option 708 of FIG. 7.

Accounts may also be arranged in a hierarchical structure if the account is for a corporation, for example, which may have a hierarchical corporate structure. For instance, if corporation A is the parent corporation, corporation A may operate as the master account. Corporations B and C may be sub-accounts having corporation A as their master account. For simplicity, display screen 900 only includes two hierarchical levels (i.e., a master account and a sub-account). This is not meant to limit the invention and more hierarchical levels may be used, if desired. Selectable option 910 allows a user to select between whether the account listed in account name 906 is a master account or a sub-account. Master account option 912 allows the user to select the master account for the account listed in account name 906. Sub-account option 914 allows the user to select the sub-accounts for the account listed in account name 906.

Display screen 900 may also include account information categorization tabs in this region 901, such as, news interest tab 916, industry interest tab 918, competitors tab 920, and contacts tab 922. Consistent with the description of FIGS. 3 and 7 above with regard to a user and contacts, respectively, the information categorization tabs provided in FIG. 9 are merely categories of information relevant for an account. These categories are provided for illustration of the invention only and are not intended to limit the invention. The categories of relevant information provided for accounts may include none, one, or more of these categories and any other relevant categories for an account

If a user selects news interest tab 916, a display screen may be provided allowing a user to update the selected account's news interests. The display screen provided may be similar to display screen 400, but it may allow a user to enter various keyphrases and other information relating to an account's news interest. The user may also select industry interest tab 918 which may allow the user to enter keyphrases and other information associated with the selected account's industry interests. The user may also select competitors tab 920 which may allow the user to enter keyphrases and other information associated with the selected account's competitors.

Upon selection of contacts tab 922 from display screen 900, a display screen may be provided showing a list of contacts associated with the selected account. This display screen may be similar to display screen 600 and may provide similar features for a user.

As will be appreciated, the description provided above with regard to creating user, account, and contact profiles is not exhaustive of all information that can be included in these profiles, but is provided merely for illustration of the present invention. Additionally information that may be included in user, account, and contact profiles may be found, for example, in the '092 patent and the '393 application, and may be included in the user, account, and contact profiles of the present invention. In addition, for aspects of the account and contacts profiles that is similar to user profiles, it may be assumed that the description from user profiles may apply equally to account and contacts profiles.

FIGS. 10-11 show illustrative contacts scoring table 1000 and accounts scoring table 1100 providing the scoring information for ranking the relevance of matched objects. The scoring information for tables 1000 and 1100 may be part of the recommendation engine's scoring system and may be stored in application database 106. The scoring information is shown, and will be discussed herein, in the form of tables 1000 and 1100 for illustrative purposes only and is not meant to limit the present invention to this storage format. The scoring information may be stored in any suitable data management format, environment, or application. It will also be appreciated that other scoring tables may be provided and the principles discussed herein apply equally to those scoring tables. For example, a scoring table for users may be provided or any other scoring table for any other category of profiles may also be provided.

As mentioned above, at step 204 in process 200, the scoring system or the scoring information for ranking the relevance of matched objects may be created/established or updated. All objects that have been identified by the CRM application to have some level of relevance will be provided to a user in some form. Because there may be too many matched objects for a user to sort through to determine which objects are more relevant than other objects, the scoring information from, for example, tables 1000 and 1100 may be used to rank the order of relevance or importance for matched objects to a user or a firm. The recommendation engine uses the scoring information from tables 1000 and 1100 along with the recommendation engine's algorithm to rank the matched objects. This algorith or algorithm is described below, for example, in connection with FIGS. 12 and 14-16. The ranking of the matched objects is used to then display the matched objects in a list in order they are ranked so that the most relevant objects appear first to a user.

In a preferred embodiment, the scoring information is established and updated by a system administrator. The system administrator may be the individual, company, and/or other entity responsible for managing an organization's computer systems. The organization referred to may be the provider of the CRM application or recommendation engine, or may also be the firm at which a relationship manager or user works. The scoring information may also be established or updated by any other individual, company, or entity.

The system administrator may create/establish the scoring information to help identify the most relevant objects for users and their accounts and contacts. Generally, the system administrator establishes scoring information tables for a particular firm, and all users within that firm operate using the same scoring information. Firms within the same industry, the same practice area, or that share other similarities, may also use the same scoring information. If a firm desires, however, the scoring information may be customized for the firm based on their specific requirements and feedback the firm provides to the system administrator as to what objects are more or less relevant. The customization for the firm may be performed when the scoring information is created/established or updated.

Typically, a firm identifies the relevance of objects based on: (1) attributes of an object itself; (2) attributes of the content found within an object; and (3) attributes of actions taken upon an object. Each of these attributes will be discussed in greater detail below. This categorization of attributes is merely provided for illustration and organization of the information to describe the present invention and is not meant to limit the invention. If applicable, other attributes categories may be used and attributes may be considered as part of more than a single category.

Attributes of an object may be organized into different classifications. Each attribute classification may be further organized into categories of that classification. Each category of attribute classifications may be further organized into sub-categories. Each sub-category can be organized into further sub-categories and further sub-categorization can continue as long as desired. For purposes of illustration of the invention, an embodiment with only three levels of organization is shown in FIGS. 10 and 11 using classifications, categories, and sub-categories. This is not meant, however, to limit the present invention to three levels of organization. As many or as few levels of organization may be used as desired. Other embodiments using more than three levels of organization may be described herein. The levels of organization may be referred to as attribute classifications, categories of the attribute classifications, and sub-categories of the categories of the attribute classifications. All levels of organization (i.e., classifications, categories, sub-categories, etc.) are all considered attributes of an object. For purposes of illustration in table 1000 and 1100, each level of organization is further indented.

Different aspects of the attributes of objects will be discussed in greater detail below, but an exhaustive list of all attributes will not be provided. Attributes discussed below are merely provided for exemplary purposes and are not intended to limit the invention. Any other attribute of an object may be used in scoring and ranking an object, including attributes of objects described above in connection with FIGS. 2-9. Essentially, the different attributes of objects and actions take on objects are intended to enable a firm or user to identify attributes or aspects of objects that are more or less relevant to the firm or user. Scoring of these different attributes is created/established and updated according to the relevance identified by the firm or user. By convention, higher numbered scores will indicate greater relevance of an object than lower numbered scores.

For an illustration of how scoring of objects' attributes may be established and updated, examples of attribute classification will described from contacts scoring table 1000. (Further details regarding the differences between table 1000 and table 1100 and the use of these tables is described below.)

As shown in table 1000 of FIG. 10, attributes of an object itself may be included in contacts attribute column 1001 and may include, but is not limited to, object attribute publication date 1002 and object attribute source type 1004. (Although objects may be provided by publication, broadcast, posting, transmission, advertisement, or any other desirable means of providing objects, for simplicity, providing of objects will be referred to herein as being through publication.) Different categories for the date an object is published under publication date 1002 may include category attribute yesterday 1006, today 1008, and date ranges 1010. Date ranges 1010 may be further sub-categorized to include, for example, sub-category attribute 2-5 days ago 1012, 10 days ago 1014, and 11-30 day ago 1016, or any other desired date range. Other embodiments may also be utilized with respect to publication date 1002, including, for example, any embodiment described above in connection with date range option 506 of FIG. 5.

Source type 1004 may be an attribute classification regarding the different types of sources of objects. For example, one category of source type 1004 may include category attribute web-based articles 1018. Other examples of source types include text files, text articles, portable document format files, video files, audio files, streaming video or audio broadcasts, television broadcasts, radio broadcast, telephone conferences, or any other type of media source or format type. For illustration of the invention as it relates to source type, web-based articles 1018 will be considered. Web-based articles 1018 may be further organized into sub-categories of web-based article attributes including, for example, sub-category attribute standard web-based articles 1020, subscription web-based articles 1022, registration-required web-based articles 1024, premium service web-based articles 1026, or any other categorization of web-based articles. For each of the source types further categorization can include the providers of the sources and different scores could be assigned to the different providers based on a firm's preference of different sources. Different providers could be, for example, the different publishers of media or different distributors of media. For example, different providers of web-based articles could be cnn.com, nytimes.com, espn.com, or any other web-based provider of articles.

The different columns and the organization amongst the columns in table 1000 will be discussed in greater detail below. For a general understanding of score assignments, column 1028 will be referred to in the below description. The scores assigned to these different attributes in contacts scoring table 1000 may depend on the industry in which the firm operates. As an example, the firm utilizing table 1000 may operate in an industry where time-relevant information is highly important. In this case, objects published today will be scored higher than the objects published yesterday. Looking at category attribute today 1008 in column 1028, the score is 800, which is higher than category attribute yesterday 1010's score of 400. This particular example indicates that an object's value may decline significantly to a firm after it has been available for over a day. It follows that the scores assigned for objects published 2-5 days ago may be much lower than the objects published today and yesterday, and even lower for objects published 6-10 days and 11-30 days ago. Looking at sub-category attribute 2-5 days ago 1012 in column 1028, the score is 100, which is lower than today 1008's score of 800 and yesterday 1010's score of 400. The score for 10 days ago 1014 and 11-30 day ago 1016 is even lower at 50 and 10, respectively.

This type of scoring or score assignments for categories and sub-categories within an attribute classification will be referred to herein as attribute ranking or attribute scoring within a classification. Attribute scoring or attribute ranking may also occur within an attribute categorization, within an attribute sub-categorization, or within any other category.

Considering the web-based attributes provided in the above example, the same firm may operate in an industry where the differences in the type of web-based content may not be as important. Therefore, the scores assigned in column 1028 for objects that are standard web-based articles 1020, subscription web-based articles 1022, registration-required web-based articles 1024, premium service web-based articles 1026, or any other categorization of web-based articles may all be the same score of 100. In this scenario, this may be referred to as attribute scoring or attribute ranking equally within an attribute sub-category. The same concept of attribute scoring or attribute ranking equally could apply to attribute ranking within attribute classifications, within attribute categories or within any other category.

Two different attribute classifications may be scored or ranked against each other. This concept will be referred to as attribute ranking or attribute scoring between attribute classifications. Attribute scoring or ranking may also occur between attribute categories, between a first attribute classification and categories and/or sub-categories within a second attribute classification, between a first attribute category in a first attribute classification and a first attribute category in a second attribute classification, and any other combination of scoring or ranking between attributes.

For example, as described above, all web-based articles have a score of 100 whereas objects published today have a score of 800 and objects published yesterday have a score of 400. In this particular example, the firm has identified that how recently an object is published should have a greater impact on the ranking of matched objects than whether an object is a web-based article.

The relevance of objects may also be ranked according to attributes of the content found within an object. As shown in table 1000 of FIG. 10, the attributes of the content of an object may include, but are not limited to, interest type 1030 and its categories of personal interest category 1032 and professional interest category 1034. These categories are provided merely for illustration and are not intended to limit the present invention. The categories provided as part of interest type 1030 correspond with the categorization tabs in tabs region 713 of FIG. 7. A further description of interest types as it relates to contact categories is discussed hereinabove in connection with FIGS. 3, 4 and 7.

As discussed above in connection with FIG. 7, upon selection of personal interests tab 716, a user can enter personal interest keyphrases for a particular contact. Although not illustrated as such in table 1000, each of the keyphrases entered by a user for a contact's personal interests may essentially be considered a sub-category of personal interest category 1032. The score assigned for each of these keyphrases is found in the score columns to the right of contacts attribute column 1001. In an embodiment containing only a singular column with scores, the score assigned for each of these personal interest keyphrases is 500 and is found in column 1028 for personal interest category 1032. For example, if two of the keyphrases inputted as a contact's personal interest are “New York Yankees” and “latest electronics,” each of these would receive a score of 500, looking at column 1028.

If desired, a further sub-category can be established for each interest type category (or keyphrase) for the number of times an interest type (or keyphrase) appears in a particular object. For example, if a keyphrase such as “New York Yankees” appears 1-2 times in an object this may be given an additional score of 20, but if it appears 3-10 times in an object this may be given an additional score of 100. In this embodiment, the score will typically increase as the frequency of a keyphrase appears in object.

As discussed above in connection with FIG. 7, upon selection of professional interest tab 718, a user can enter professional interest keyphrases for a particular contact. Again, although not illustrated as such in table 100, each of the keyphrases entered by a user for a contact's professional interests may essentially be considered a sub-category of professional interest category 1034. In one embodiment containing only a singular column with scores, the score assigned for each of these professional interest keyphrases is 300 and is found in column 1028 for professional interest category 1034.

A further attribute of the keyphrases entered by a user (as part of any interest type) may be whether the keyphrase entered is part of an advanced search. For simplicity, the advanced search feature is indicated in table 1000 as a separate attribute classification at advanced search 1036. It may be desirable to rank matched objects that are matched as a result of an advanced search higher than other matched objects. This may be desirable because an advanced search indicates that a user meticulously entered keyphrases or search terms or selected other search filters, such as those provided in connection with advanced search display screen 500 of FIG. 5. The effort expended by a user in creating an advanced search for a particular contact's interest may indicate that objects matched as a result are of greater relevance than those objects matched as a result of a standard search. The aforementioned embodiment may also be illustrated in table 1000 by including the advanced search feature as a further sub-category under each keyphrase. (As a reminder, the keyphrases themselves may essentially be considered sub-categories under each interest type—i.e., personal interest category 1032, professional interest category 1034, etc.).

In another embodiment (not illustrated in table 1000), the recommendation engine may also consider if an advanced search or standard search has been added or modified recently. Recent addition or modification of a keyphrase may indicate that a user finds this most recent addition or modification to be of greater relevance to the user and may desire seeing objects that match this keyphrase. It may desirable to phase out the impact of the relevance of this addition or modification quickly (i.e., within an hour, a day, a week, etc.) or after some time (i.e., within a few hours, a few days, a few weeks, etc.). This embodiment could be illustrated in table 1000 by including another sub-category under each keyphrase indicating the desired attributes (i.e., when added or modified) for scoring the freshness of a keyphrase's addition or modification.

Contacts scoring table 1000 may include two sets of columns, contact classification “A” 1038 and contact classification “B” 1040, to indicate the different contact classifications/priorities. While table 1000 includes only two sets of columns for two contact classifications/priorities, the present invention is not limited to only two contact classifications. Rather, this embodiment is merely provided for illustration of the invention. Thus, additional sets of columns may be provided that correspond to additional classifications provided in other embodiments. The contact classifications/priorities in table 1000 may correspond to the classification level for a contact assigned using priority option 708 from FIG. 7 or the priority level indicated for a contact by priority 614 in FIG. 6. Alternatively, contact classification/priorities in table 1000 may correspond to the alternative embodiments described in connection with FIGS. 6 and 7.

The presence of the contact classification columns indicate that different contacts may have different priorities to users. For instance, two contacts within the same account (which may be for a financial institution) may have different contact classifications to indicate, for example, that one contact has a high level position in the account (e.g., president) and that the other contact has a low level position in the account (e.g., analyst). Similarly, two contacts associated with two different accounts may have different contact classifications depending upon how important those accounts are to the user. These examples of reasons why a user may rank one contact as a higher classification than another contact are provided merely for illustration and is not meant to limit the present invention.

In the preferred embodiment, each set of classification columns may include a subset of columns regarding the priority selections a user may choose for a particular attribute. In another embodiment, the priority selections for some of the attributes may be chosen by a user and priority selections for the other attributes may be chosen by the firm and/or the recommendation engine. In a further embodiment, the priority selection for the attributes may be chosen by the firm or the recommendation engine, or both. For purposes of illustration the preferred embodiment will be described herein.

The priority selections for attributes may allow a user to further identify the basis for which the recommendation engine determines what objects are relevant. As described above in connection with FIG. 4, for example, each keyphrase inputted by a user (whether the keyphrase is for a user's, contact's, or account's interest or interests) includes a corresponding priority selection (408). The priority selection is illustrated as having five different priority options: alert (410); “A” (412); “B” (414); “C” (416); and none (418). Similarly, each set of classification columns has five priority columns corresponding to these priority selections. For illustrative purposes, columns for contact classification A 1038 are examined. Contact classification A 1038 may include alert priority column 1028, “A” priority column 1042, “B” priority column 1044, “C” priority column 1046, and none priority column 1048. These columns may correspond to the priority selections (408) provided in connection with FIG. 4. As will be appreciated, a priority selection may be made for each attribute in attribute column 1001 and the present invention is not limited to such priority selections for keyphrases and interests only.

As described above, other priority selection embodiments may also be provided and the columns for each set of contact classifications may correspond with the priority selection embodiment being utilized. For example, if a numbering scheme is used, columns may exist for each number used to indicate a priority. In another embodiment, ranges of the numbers inputted by users may be utilized for each column. For example, if the user can input a number between 1-100 to indicate a priority for an attribute and five columns are utilized, 1-20 may correspond with alert priority column 1028, 21-40 may correspond with A priority column 1042, 41-60 may correspond with B priority column 1044, 61-80 may correspond with C priority column 1046, and 81-100 may correspond with none priority column 1048.

Another priority selection embodiment may correspond with the embodiment described in connection with priority selection 408 where a user may input or sort keyphrases in order of priority. In this embodiment, each keyphrase may correspond to a priority column in table 1000. Alternatively, if there are five priority columns in table 1000, keyphrases may be grouped together based on their percentage ranking in priority order. For example, the top 20% of all keyphrases may correspond with alert priority column 1028. If there are ten keyphrases, then the first two keyphrases in the priority list of keyphrases may correspond to alert priority column 1028. It will be appreciated that other percentages may be used based on the number of priority columns in table 1000. It will also be appreciated that all of the different embodiments from FIGS. 3-9 that have not been included in tables 1000 and 1100 of FIGS. 10 and 11, respectively, may be included as attributes in tables 1000 and 1100, either in addition to or instead of certain attributes.

By convention, the scores in the priority columns may decrease from left to right within each set of contact classification columns in accordance with the decreasing level of priority. This scoring convention may indicate that an alerted priority has the highest priority because the score is the highest for that attribute, and each successive priority level has a lower priority because the scores are lower for that attribute. Therefore, attributes with higher priorities may receive higher scores.

By convention, the scores in corresponding priority columns of different contact classifications may decrease from left to right as well. For example, for each attribute, the score assigned to alert priority column 1028 of contact classification A 1038 is greater than the score assigned to alert priority column 1060 of contact classification B 1040. The same applies for A priority column 1042 in contact classification A 1038 and its corresponding A priority column in contact classification B 1040, and every successive priority column. This scoring convention may indicate that, all else being equal, a higher contact classification has a greater impact on an object's score than a lower contact classification. Thus, a higher contact classification affects how relevant an object is. This scoring convention and its impact will be described in greater detail below, for example, in connection with FIG. 12.

For illustration, looking back at one of the examples provided above, two of the keyphrases that may be inputted for a contact's personal interest as “New York Yankees” and “latest electronics.” When these personal interests are inputted, the “New York Yankees” keyphrase may be specified as an alerted keyphrase and “latest electronics” may be specified as a priority B keyphrase. If the contact being considered is a contact classification A, then the looking at personal interest category 1032 and alert priority column 1028, an object with content regarding the “New York Yankees” would receive a score of 500. Looking at priority B column 1044, an object with content regarding the “latest electronics” would receive a score of 85. These priority options may allow a user to provide feedback as to what attributes are more or less important to the user, thus affecting the scoring and ranking of objects. Similarly, priority selections may be made by the user, the firm, the recommendation engine, and/or the system administrator either manually or automatically for the other attributes, and their categories and sub-categories.

The relevance of an object may also be ranked according to actions taken upon an object. As shown in table 1000, one attribute classification may be actions attribute 1050. The categories of actions may include clicked on by user 1052, printed by user 1054, e-mailed by user 1056, and viewed by recipient 1058. Other desired actions may include saving an object, contacting a contact by phone about an object, or any other desired actions. The corresponding scores found in any of the priority columns (e.g., 1028, 1042, 1044, 1046, 1048, etc.) may include the scores assigned to each of these actions. In table 1000 all of these actions have been assigned the same score of 10 regardless of the classification of the contact or the assigned priority. This is merely provided as illustration and is not meant to limit the present invention. The functioning and scoring of the action attribute will be discussed in greater detail below in connection with FIG. 12. The purpose of tracking user and recipient (e.g., contacts) actions is because it provides a further understanding of the relevance of an object. The more times a user e-mails an object to contacts, for example, the higher the likelihood is that this object is relevant to users, contacts, and/or accounts. While the user who e-mailed the article may have already identified the object as relevant and would not necessarily benefit from this action being tracked, other users would benefit from this action being tracked and its identification as being relevant.

The user who took an action on an object, such as e-mail, may, as will be described below, use the CRM application to discover that other contacts might find the object relevant. The CRM application may provide the user with a list of contacts who have keyphrases that match the object. It may, however, be even more beneficial to provide a user with a list of contacts having the same keyphrase in their contacts' profiles as the contact that caused the user take action upon the object (e.g., e-mail). For example, the keyphrase “New York Yankees” is in an object and the user e-mails contact #1 the object because he believes contact #1 may be interested in the object. The keyphrase “baseball” may also be in the object causing the object to match contact #2. It may be beneficial to recommend this object more strongly to contact #3 than contact #2 because contact #3 has the same keyphrase “New York Yankees” in his contact profile as contact #1.

Accounts scoring table 1100 of FIG. 11 shows the scoring assigned for accounts and, where appropriate, may have a similar structure and similar functioning as contacts scoring table 1000. For brevity, the description of table 1000 applies equally to table 1100, except where specifically described as being different.

Table 1100 includes accounts attribute column 1101 and may include the same, more, less, or different attributes listed in contacts attribute column 1001 of FIG. 10. The attributes for accounts may be different for contacts simply because what is relevant for an account may be different than what is relevant for a contact. One example of different attributes may be the categories for interest types. Object content attribute interest type 1030 of FIG. 10 for contacts included personal interest category 1032 and professional interest category 1034. While these categories could apply equally to accounts scoring table 1100, object content attribute interest type 1102 from scoring table 1100 includes, but is not limited to, new interest category 1104, industry interest category 1106, and competitor interest category 1108. A personal interest category may not be as appropriate for an account because, as indicated above, an account is associated with an employer of contacts and is an entity not a person with personal interests. At the same time, a personal interest category may be appropriate for an account if all the contacts within an account have common personal interests. Other differences between contacts and accounts may be noted among the attributes in attribute column 1101. The interest type categories provided as part of accounts table 1100 may correspond with the categorization tabs in tabs 901 of FIG. 9.

Scoring table 1100 may also include sets of columns for account classifications or priorities, such as account classification “A” 1110 and account classification “B” 1112. The presence of the account classification columns may indicate that different accounts have different priorities to users or firms. For instance, two accounts, which may be both financial institutions, may have different account classifications to indicate disparities in financial contributions to a firm's business. For example, one account may provide billions of dollars of the business to the firm (classification A) and another account may provide millions of dollars of business to the firm (classification B). Similarly, two accounts which may be in different industries may have different contact classifications depending upon how important or how much business a user or firm does in that particular industry. These examples of reasons why a user or firm may rank one account as a higher classification than another account are provided merely for illustration and is not meant to limit the present invention.

Although not shown, a scoring table may be provided for a user or a firm, if desired. In a preferred embodiment, the scoring table for a user or firm may also include sets of columns for classification, such as in contact or account classifications of FIGS. 10 and 11, respectively. For a user table, user classifications may be determined based upon a user's position at the firm (e.g., president is classification A and analyst is classification C).

One embodiment of a process that may be used to score an object, in accordance with the principles of the present invention, is illustrated in process 1200 of FIG. 12. At step 1202 attribute scores for a particular object may be determined and summed together to arrive at an unweighted object value. As will be discussed in greater detail below, the scoring of an object will be used to determine an object's Total Object Value (“TOV”) at Step 1210. Each object will be scored “n” number of times where “n” represents the total number of contact classifications, account classifications, user classifications and firm classifications. As a reminder, with reference to scoring tables 1000 and 1100, the classifications refer to the sets of columns, such as contact classification A 1038 and contact classification B 1040. In an alternate embodiment, “n” may represent the number of contact and account classifications. For illustration, the formula for the unweighted object value for a particular classification A may be as follows:

$$Unweighted Object Value for Classification = \begin{matrix} & Publication Date Score \\ + & Source Type Score \\ + & Interest Type Score \\ + & Actions Score \\ + & Advanced Search Score\end{matrix}$$

The formula provided may also include any other attributes desired to be included in the formula for determining the unweighted object value for an object for a particular contact classification.

At step 1204, a hit rate for a particular object may be determined. For each time, of the “n” number of times, an object is scored, a hit rate may be determined for how many times an object is matched to members of a classification (e.g.,accounts in an account classification). For illustration, consider the hit rate for contacts in contacts classification “A.” (The following illustration applies equally to each of the contacts, accounts, and other classifications.)

The hit rate for this classification may be determined by dividing the number of contacts in contacts classification A that matched the particular object by the total number contacts. The formula for the hit rate may be as follows:

$$Hit Rate of Classification ( A ) Contacts = \frac{Number of Classification ( A ) Contacts Hits}{Total Number of Contacts}$$

Note that in the preferred embodiment of the present invention, the denominator of this formula is the total number of contacts for all classifications. In other embodiments, the denominator of this formula may be the total number of contacts in contacts classification A or the classification being analyzed. The total number of contacts may also be the total number of contacts for a particular user or for a particular firm. For illustration of the invention, it will be assumed herein that the total number of contacts being considered is for a particular user in all classifications. Moreover, generally speaking, the denominator of the formula may refer to the total number of members in the particular type of classification being analyzed.

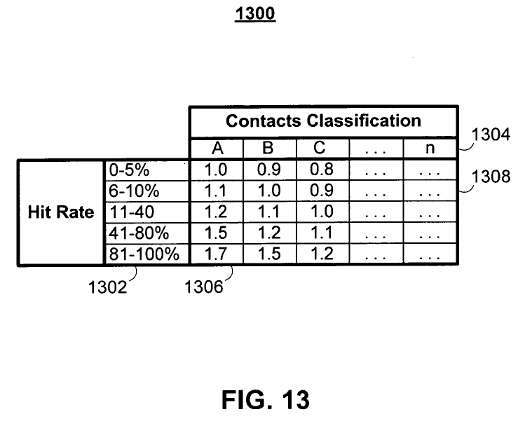

At step 1206, the hit rate weight may be determined for a particular object based on the particular classification being analyzed. The hit rate weight will be discussed in further detail below in connection with hit rate weight table 1300 of FIG. 13. Generally speaking though, the hit rate weight may be a multiplier for the unweighted object value. The hit rate may increase as the hit rate increases. The hit rate weight impacts the score of an object and thus the relevance ranking of the object. A weighted score is provided to increase the score for objects that have been matched by a greater number of members of a classification relative to objects that have been matched by a fewer number of members.

After the hit rate weight is determined at step 1206, the weighted object value for a particular classification is determined at step 1208. The weighted object value for a particular classification is determined by multiplying the sum of attribute values for a particular object scored at step 1202 (i.e., unweighted object value) by the hit rate weight determined at step 1206. The formula for determining the weighted object value for a particular classification may be as follows:

$$Weighted Object Value For Classification = U nweighted Object Value For Classification \times Hit Rate Weight For Classification$$

Once all of the weighted object values for each classification are determined by repeating steps 1202 through 1208 for each classfication, the weighted object values for each classification finally determined at step 1208 may be added together to determine the Total Object Value (TOV) at step 1210. In practice, one or more steps shown in process 1200 may be combined with other steps, performed in any suitable order, performed in parallel—e.g., simultaneously or substantially simultaneously—or deleted. For example, steps 1204 and 1206 may be performed before or in parallel with step 1202.

For a better understanding of how a TOV is determined, a fictitious object “X” will be considered. It may be assumed that object X published today as a web-based article that requires registration for access about playoff tickets for the New York Yankees. In this example, object X will be analyzed using contacts scoring table 1000 looking at the set of columns corresponding to contact classification A 1038. It will be understood that the same principles may apply to determining object values for accounts, users and firms.

It may also be assumed that the user set the user profiles such that the publication date (1002) has an alert priority (1028) and source type has B priority (1044). One of the keyphrases that has been inputted by the user for two of the contacts may be “New York Yankees.” This keyphrase may have been set as an A priority (1042) as a personal interest type in each of these two contacts' profiles. Another of the keyphrases that has been inputted by the user for two of the contacts may be “playoff tickets.” For one of the contacts this keyphrase may have been set as an alert priority (1028) in the contacts' profile and for another of the users this keyphrase may have been set as a C priority (1046) in the contacts' profile. It may be assumed that neither of these keyphrases was part of an advanced search (1036). It may also be assumed that this object was clicked on by the user three times, e-mailed by the user to three of the contacts, and viewed by two of the recipients (i.e., contacts).

Following process 1200, at step 1202, the unweighted object value is determined when the object is first published and the object is determined to be a match for at least one of the contacts. It is first assumed that object X matched to at least one contact of the user's contacts. Looking now at table 1000, the unweighted object score for object X will be scored by analyzing each attribute and will be discussed herein by considering each row (from top to bottom) of table 1000. For the sake of simplicity the reference numerals provided to the left of the table 1000 in FIG. 10 may be used to refer to the row the reference numeral identifies in table 1000, where appropriate. Similarly, the reference numerals provided below table 1000 in FIG. 10 may be used to refer to the column the reference numeral identifies in table 1000, where appropriate. The intersection of a row and column may refer to a particular cell in a table.

The total score under publication date attribute 1002 is 280 because object X was published today and publication date has an A priority, (see row 1008, column 1042). At the time the object is published, none of the other scores provided in rows 1006, 1008, 1012, 1014, and 1016 and columns 1028, 1042, 1044, 1046, and 1048, with the exception of the score at row 1008 and column 1042, will affect object X's score with respect to its publication date.

In addition to determining the unweighted object value at step 1202 when an object is first published, it may also be determined periodically after the object is published. For example, the unweighted object values may be recalculated each hour, each day, after a determinate amount of clock cycles of a processor in any of the devices in user equipment 102, or at any desired frequency. As will be discussed below in greater detail below with respect to user or recipient actions, object scores can also be recalculated in response to a user or recipient action. Therefore, when step 1202 is performed three days after object X is published, the publication date's score may no longer be 280 (see row 1008, column 1042), but rather may be 35 (see row 1012, column 1042).

The total score under source type 1004 is 17 because object X is a web-based article requiring registration for access and the user selected that source type should be granted a B priority. Therefore, the score is determined by looking at row 1024 and column 1044.

The total score under interest type 1030 is 875. In the previous two examples of analyzing different attribute classifications, the score for that attribute was determined by locating a particular cell in table 1000 that matched the qualifications of object X. Interest type 1030 is different than the above examples because there are multiple matches that qualify for scoring of object X (i.e., multiple scores from multiple cells contribute to the interest type score). One of the keyphrases entered for two separate contacts was “New York Yankees” as a personal interest type. As described above in connection with FIG. 10, this essentially creates two separate sub-categories to personal interest type 1032 for each of the two contacts that the user entered this keyphrase as a personal interest. The scoring associated with these sub-categories may be identical to the scoring found in row 1032. Therefore, because the keyphrase “New York Yankees” is found in object X, there are two separate additions of a score of 175 because this is an A priority (see row 1032, column 1042), making the running subtotal score 350 for interest type 1030.

The keyphrase “playoff tickets” was also inputted by the user for two separate contacts but given an alert priority for one and a C priority for another. This too will essentially create two separate sub-categories under personal interest type 1032 for each of these two contacts. Because the keyphrase “playoff tickets” is found in object X, there is an addition of 500 for the alert priority to the running subtotal score (see row 1032, column 1028) and 25 for the C priority to the running subtotal score (see row 1032, column 1046). These additions, make the total score 875 (i.e., 350+500+25) for interest type 1030.

As indicated above, this example of scoring attributes of interest type 1030 illustrates a contrast to the attributes of publication date 1002. Interest type 1030 has the potential of multiple matches contributing to the score of object X, while publication date 1002 had only the potential of a single match contributing to the score of object X. Publication date 1002 may only have the potential of a single match contribute to the score because the publication date can be only one of today, yesterday, 2-5 days ago, 6-10 days ago, and 11-30 days ago. Other attributes can also be established such that only a single match for that attribute can contribute to the score of an object. In other embodiments, publication date 1002 can be established such there may be a potential of multiple matches. For example, one category of publication date attribute may be yesterday and another category of publication date attribute may be 1-5 days ago, meaning that if an object was published yesterday it would match both of these categories.

Referring back to the example, regardless of the priority given to an advanced search, since no advanced searches were performed, no score is added looking at the “no” category of advanced search 1036.

The total score under actions attribute 1050 is 80. As described above, object X was clicked on by the user three times, e-mailed by the user to three of the contacts, and viewed by two of the recipients. Regardless of the priority column or the action, according to scoring table 1000, each of these actions increases the score by 10. With a total of eight actions, the total score under actions attribute 1050 is 80. In other embodiments, the scoring table may be established such that clicking an object is given a lower score than e-mailing an object because e-mailing an object implies that a user finds an object has greater relevance than just clicking on the object. On the other hand, in some systems, in order to e-mail an article the object must previously be clicked on, so making each action of equal weight may take this principle into account.

Returning to the example, all of the attributes must be summed together to arrive at an unweighted object value. The total unweighted object value equals 1252−i.e., 280 (publication date of yesterday)+17 (source type is web-based article requiring registration for access)+875 (interest type)+0 (advanced search)+80 (actions take on object). However, as described above, when the object was initially published, none of the actions (e.g., clicks, e-mails, etc.) were taken upon the object. Therefore, the initial score was 1172. If the eight actions described above occurred in the same day, then the score would increase to 1252 after all eight actions were taken. Therefore, as the day went along, the relevance of a particular article may rise and depending upon the score of other objects, it may become more relevant than other objects provided to a user. Although, this description describes that all eight actions impacted the score at once, it will be appreciated that these eight actions can contribute to the score as the action is taken or periodically as the score for an object is recalculated, consistent with the description of this process provided above.

The hit rate for object X can be determined at step 1204. Object X will be assumed to have been matched to two of user's ten total contacts in contacts classification A. Although other classifications of contacts have not be discussed in this example, it will be assumed that the user has ten other contacts in various other classifications. Therefore, the hit rate for object X in contacts classification A is 10% (2 hits/20 total contacts).

In the preferred embodiment, the number of matches or hits to an object are based on how many contacts matched the object based on any of the keyphrases associated with contacts' profiles. Therefore, if one contact matches a particular object because five of the keyphrases in the contact's profile are included one or more times in the content of the object, this counts as a single match or hit. In the same way, if another contact matches a particular object because only one the keyphrases in this contact's profile is included only once in the content of the object, this too counts as a single match. The manner by which the different number of keyphrases impacts the score of an object may occur through the score increasing by the number of keyphrases (or sub-categories to an interest type) that match.

At step 1206, the hit rate weight is determined for object X. Hit rate weight is determined by looking at hit rate weight table 1300 of FIG. 13. Hit rate weight table includes hit rates 1302 and contacts classifications 1304. (Separate hit rate weight tables may be provided for the other types of classifications.) Distribution of hit rates 1302 is provided in table 1300 merely for illustration and is not meant to limit the invention. The number of distributions of hit rates (i.e., rows in table 1300) may be fewer or greater than that provided in table 1300 and the percentage differences between each distribution may be greater or less for each of the distributions. Contacts classifications 1304 corresponds to contact classifications discussed above and as indicated by including A through “n”, classifications, the number of contacts classifications provided in table 1300 is also provided merely for illustration and is not meant to limit the invention. Contacts classification A column 1306 may be examined because the example regarding object X refers to contacts classification A. In this example, object X had a hit rate of 10%, therefore, 6-10% row 1308 may be examined to determine that the hit rate weight is 1.1. While the hit rate weight is determined by table 1300, this is merely for illustration and is not meant to limit the invention. Other methods by which the hit rate weight could be determined include using a formula, a random-number generator, or any other desirable method of determining a hit rate weight.

Returning back to process 1200, at step 1208 the weighted object value of object X may be determined by multiplying the unweighted object value by the hit rate weight. If the unweighted object value determined at step 1202 is 1252 and the hit rate weight determined at step 1206 is 1.1, then the weighted value of object X for contacts classification A is 1377.2. This process of determining the weighted value of an object (i.e., steps 1202 through 1208) is then repeated for each contacts classification, accounts classification, user classification, firm classification and any other classification. The weighted values of the object for each classification is then added together at step 1210 to arrive at the Total Object Value (TOV).

FIG. 14 shows illustrative display screen 1400 provided by the CRM application when a user logs in to the application. Display screen 1400 may provide the user with various functions and information. Systems and methods for various CRM application menu options, functions, and information are discussed in more detail in the '092 patent and the '393 application, which are incorporated by reference herein.

Display screen 1400 may include contacts frame 1402, which may include a list of the user's contacts, the corresponding contacts' accounts, the contacts' classification or priority designation, and any other relevant information to the contacts. Any of the information in contacts frame 1402 may be hyperlinked or selectable to allow the display of information relating to the contact. For example, contact link 1404 may be selectable allowing the user to view the profile, search results screen, or any other information for the contact that corresponds to contact link 1404. Similarly, account link 1406 may be selectable allowing the user to view the profile, search results screen, or any other information for the account that corresponds to account link 1406. Contacts frame 1402 may also include the user as part of the list and provide a hyperlink or selectable option 1408 to allow the display of the user's profile, search results screen, or any other information for the user. Display screen 1400 may indicate which individual in contacts frame 1402 is the user by distinguishing the text in same way (e.g., bolding, locating an asterisk next to the name, etc.). Currently, a search results screen for the user is displayed in display screen 1400.

Display screen 1400 may include menu tabs 1410 that include tops call tab 1412, contacts tab 1414, accounts tab 1416, research tab 1418, and search tab 1420. As indicated by the highlight, contacts tab 1414 is currently selected. When contacts tab 1414 is selected the user may see search results screen for any user or contact. For clarity and brevity, all references to the information displayed about the user and contacts in display screen 1400 apply equally.

Search results frame 1421 may be shown in display screen 1400 and may include personal frame 1422, professional frame 1424, or any other frame for the categories of interests discussed above. Frames 1422 and 1424 may display the keyphrases of interest the user entered for the user or contact in a display screen, such as display screen 400. Checkbox 1426 and its corresponding keyphrase 1428 may be selectable. Selecting checkbox 1426 or keyphrase 1428 may allow a user to enable or disable searching the various sources for information corresponding to that keyphrase.

Results frame 1430 may be provided in display screen 1400. Results frame 1430 may include personal results frame 1432, professional results frame 1434, or any other frame providing the search results of objects in the categories of interest for a user or contact. Results frame 1430 may also provide a search results list of all objects that match the user's interest. This search results list may be provided instead of or in addition to including frames 1432 and 1434 in frame 1430. It will be understand that the objects themselves may or may not be provided in results frame 1430. In the preferred embodiment a listing corresponding to an object may be provided in results frame 1430. Systems and methods for matching objects are discussed in more detail above in connection with step 206 of process 200.

Searches for objects may be scheduled by the user to occur at a particular time, occur continuously at a time interval determined by the user, or by any other method. The list of selectable objects may be dynamically updated each time the CRM application automatically initiates a search.

Objects included in any list of objects may be stored in an application database (e.g., application database 106 of FIG. 1), cached in the memory of a device included in user equipment 102, or otherwise stored using any suitable method. The list of objects may include information related to the interests, the date the object was published, and the source of the object. A user may also be presented with the option to retain an object or delete an object from the list. By selecting a retain option, the corresponding object may be stored in the application database and have a data attribute indicating that the object is retained. By selecting delete option, a user may remove the corresponding object from application database 106.

As will be appreciated, objects may be matched based on a particular profile, and specifically, the keyphrases associated with the profile. Objects may also be matched in accordance with other aspects of the profile. As noted above in connection with the discussion of interest types, each profile may be segmented to include different interest types (e.g., personal, professional, etc.) and have keyphrases associated with the specific interest types for the profile. When objects are matched to a profile based on certain keyphrases, the objects may also be matched to the particular interest types of the profile. Therefore, when the objects are matched and object listings are provided in display screen 1400, the object listings may be included in the search results list of the particular frame corresponding to the interest type for which the object was matched.

For example, as noted in personal frame 1422 of FIG. 14, user Adam Smith has keyphrase “Management” as one of his personal keyphrases. In personal results frame 1432, objects list 1436 may include the objects matched to Adam Smith's personal keyphrase searches. As shown in the interest column of objects list 1436, all objects matched shown were based on the keyphrase “Management” which is a keyphrase from the personal interests. Although objects list 1436 includes only two object listings, ellipses 1444 indicate that more than two objects listings may also be provided. Ellipses are provided in other parts of display screen 1440 and may be provided in other display screens to indicate that more information may be provided like the information noted before the ellipses.

As described in step 208 of process 200 of FIG. 2, once objects are matched, the objects may be ranked using the recommendation engine. All objects may be scored and ranked in accordance with the description provided hereinabove. At step 210, the objects or objects listings may be provided to the user in order based on the ranking. Personal results frame 1432 includes object listing 1440 and object listing 1442 which may be two listings for objects that matched keyphrases in the user's personal interests aspect of the user's profile. Object listings 1440 and 1442 may be provided in object list 1436 in the order in which they were ranked. Object listing 1440 may be provided first in object list 1436 because the object corresponding to object listing 1440 received a higher score than the object corresponding to object listing 1442. In this scenario, providing the highest ranked object on the top of the list may be considered a top-down or top-first display of ranking objects. Alternatively, object listing 1440 may correspond to the lowest ranked object and may be provided first in object list 1436.

Objects listings may be provided in the order of ranking in any desirable manner. For example, object listings may be provided in a listing from left to right where the object listing on the left in the display is the highest ranked object and the object listing on the right in the display is the lowest ranked object. Alternatively, the highest ranked object may be provided on the right and the lowest ranked object may be provide on the left. Icons or other indicators may also be provided next to or adjacent each object listing to indicate the relevance of the object. For example, certain icons may indicate that an object associated with an object listing is particular relevant to a user, contact, or account because it meets a predetermined threshold score, because the object was matched because one of the keyphrases it matched had an alerted priority, or for any other reason it may be desired to distinguish an object. Other indicators may also be used to indicate the relevance of an object. For example, shading, coloring, font size, font style, flashing text, or any other adjustment to the object listing may indicate that an object is more or less relevant.

Indicators may also be provided to indicate if an object's score has increased due to a large number of actions being taken on an object by users, contacts, accounts for a firm. For example, if an object is being viewed, printed, e-mailed, saved, or clicked on by many users, an object's score may increase. If the CRM application notes an increase of a score over a certain (or short) amount of time, it may indicate that an object is extremely relevant. The CRM application may indicate this increase in score using one or more of the above indicators described. The CRM application may also indicate the increasing score of an object by elevating the location of its corresponding listing in the object list beyond what the objects score may normally indicate. For example, if object A has a score of 100, object B has a score of 80, and object C has a score of 70, the objects may normally be displayed in the following order: object A, object B, object C. If, however, object C's score has increased by 10 in a short amount of time, it may be desirable to provide object C before object B such that the objects may be displayed in the following order: object A, object C, object B. It may be desirable to provide object C before object B because the interest and relevance of the object is increasing. This type of ranking may be considered a predictive aspect of the ranking because the CRM application is predicting the relevance of an object.

Different object listings may be provided based on the categories of interest types and may also be ranked within each interest type. In display screen 1400, object listings may be provided in personal results frame 1432, professional results frame 1434, and any other interest type frame provided. The object lists in each of these frames may be provided in the order that the objects were ranked or scored as compared to the other objects of the same interest type. Alternatively, a single list of all objects matched to a particular user, contact, account, or firm may be provided in order in which the objects were ranked or scored.

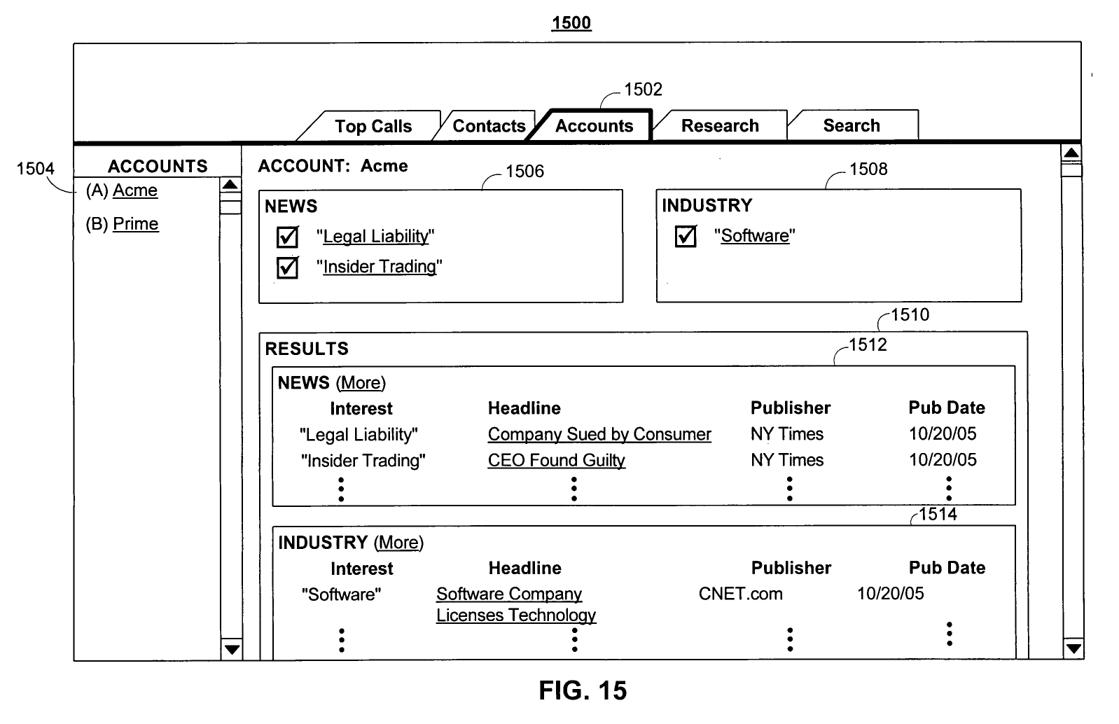

FIG. 15 shows illustrative accounts display screen 1500 which may be displayed in response to selecting accounts tab 1416. In display screen 1500, accounts tab 1502 is highlighted to indicate that it has been selected. Accounts display screen 1500 is similar to display screen 1400 which displayed search results for contacts. Display screen 1500 will be described briefly and the description regarding display screen 1400 applies equally to display screen 1400. Display screen 1500 may include accounts frame 1504 which may include a list of the user's accounts and the corresponding accounts' classification or priority designation. Display screen 1500 may also include news frame 1506, industry frame 1508, and any other frame for the categories of interest discussed above for accounts (e.g., competitors).

Results frame 1510 may be shown in display screen 1500 and may include news results frame 1512, industry results frame 1513, or any other frame providing the search results of objects in the categories of interest for an account. Objects may be matched in accordance with aspects of an accounts profile and provided in order of relevance in the appropriate frame or frames based on a process similar to that described in connection with FIG. 14.

In response to a user selecting research tab 1418 of display screen 1400 of FIG. 14, a display screen may be displayed similar to display screens 1400 and 1500. The information in this display screen may relate to an account, contact, user's, or firm's financial holdings. Rather than displaying keyphrases based on interest type as in display screens 1400 and 1500, this display screen may display a list of the user's financial holdings and a list of financial holdings in which the user has interest. In addition, rather than displaying search results based on interest type, this display screen may display search results based on a list of the user's financial holdings and a list of financial holdings in which the user has interest. The object listings that are part of these search results may also be ranked in accordance with the progress described above in connection with FIG. 14.

In response to a user selecting search tab 1420, a user may perform any desired search for objects or holdings, including perform advanced searches. Search tab 1420 may provide a user with an opportunity to fine-tune keyphrases. Once a desired keyphrase has been determined that provides the desired search results, the user may add this keyphrase as part of a user's, contact's, or account's profile. If desired, the recommendation engine may score objects higher that were matched based on a keyphrase that was entered initially through search tab 1420 because it indicates that the keyphrase is important to the user since the user spent time fine-tuning the keyphrase.

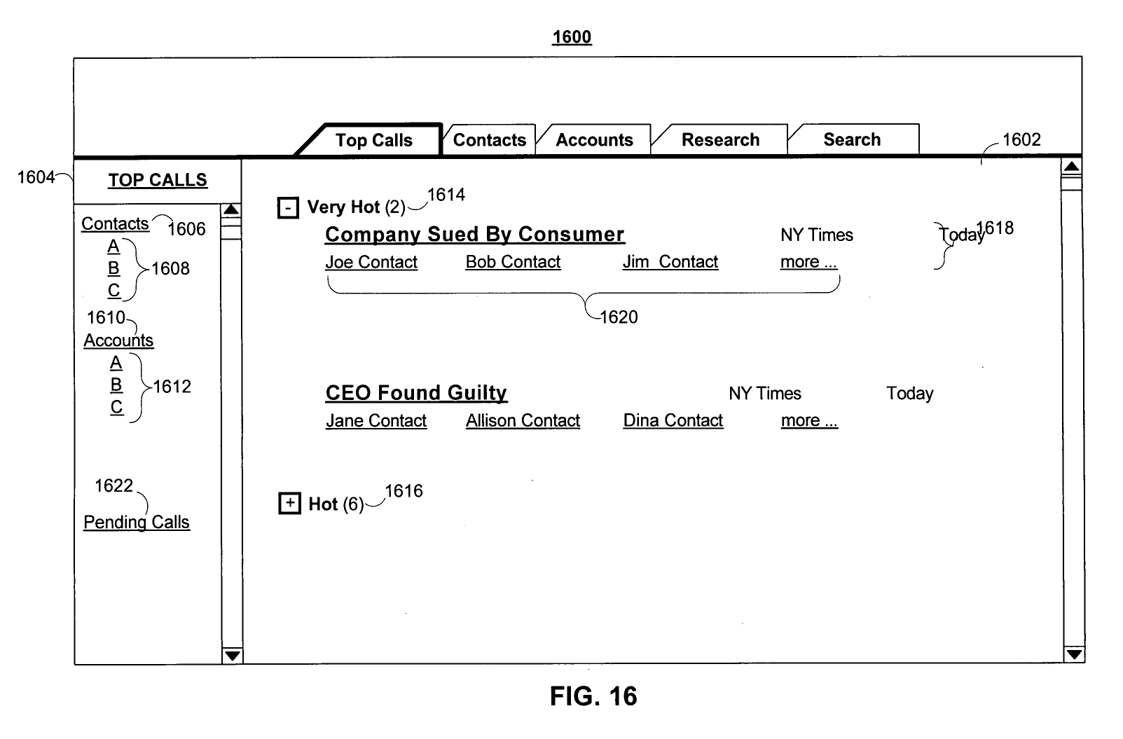

In response to the user selecting top calls tab 1412, top calls display screen 1600 of FIG. 16 may be displayed. Illustrative display screen 1600 may show object listings 1602 which includes the top scored objects of all objects that have been matched to users, contacts, accounts or firms. Options frame 1604 includes selections for groupings of top scored objects, such as, contacts option 1606, contacts classifications options 1608, accounts option 1610, accounts classifications options 1612, and any other grouping of individuals.

Upon selection of contacts option 1606, display screen 1600 may display the top scored objects of all objects that match keyphrases inputted by the user for contacts. Object listings 1602 may include groupings based on scores, such as very hot group 1614 and hot group 1616. Very hot group 1614 may include the top ten scored objects or any desired number of scored objects. As shown in display screen 1600, very hot group 1614 includes the top two scored objects, as indicated by the number in the parentheses. Grouping of scored objects may be grouped based on a certain number of ranked objects (e.g., top fifty objects ranked, objects ranked twenty to thirty, etc.), based on a percentage of the ranked objects (e.g., the top ten percent of all matched objects, matched objects in the tenth to twentieth percentile, etc.), based on receiving a TOV score above a certain score (e.g., all objects above a TOV of 1000, all objects between a TOV of 500 and 1000, etc.), or based on any other grouping based on objects' scores.

Like all other grouping of objects, very hot group 1614 may includes a list of objects listings. Object listing 1618 may be one of the object listings part of very hot group 1614. Object listing 1618 may include the object title (which may include a link to the object), the source of the object, the date of publication, and any other relevant information for an object. In addition, below the object title, the object listing may include contacts listing 1620. Contacts listing 1620 may include all contacts that match the object of object listing 1618. If all of the contacts that match the object of object listing 1618 cannot be included on the screen, more option 1621 may be included as part of its contacts listing 1620 to provide a list of the remaining contacts or a full list of contacts that match an object. Each of the contacts listed may include hyperlinks or other selectable options with the name to access the contact's profile or to provide any means of contacting the contact to inform them of the object (e.g., e-mail, phone, etc.).

Contacts listed in contacts listing 1620 may be listed in order of contact classification or account classification. Contacts may also be listed in order of which contacts may be most interested in the object. For example, the same keyphrase that prompted the object to match two contacts may be in the two contacts' profiles. In a first contact's profile, the keyphrase may be listed as an alert priority and in a second contact's profile, the keyphrase may be listed as a C priority. The first contact may be listed first in contacts listing 1620 because this keyphrase has a higher priority to the first contact than the second contact. Contact listing 1620 may list individuals in any order that provides the user with an indication of which individuals the user may be most interested to contact, which individuals may be most interested in being contacted about the object, or any other desired order.

Top scored objects may also be grouped according to contacts classification, accounts, and accounts classifications, as indicated in options frame 1604. If a user selects “A” from contacts classification options 1608, display screen 1600 may display top scored objects that are matched to contacts included in contact classification A. The same follows for all other contacts classifications, such as those provided in contacts classification options 1608. Upon selection of accounts option 1610, display screen 1600 may display the top scored objects of all objects that match keyphrases inputted by the user for accounts. If a user selects “All from accounts classification options 1612, display screen 1600 may display top scored objects that are matched to accounts included in classification or priority level A. The same follows for all other the accounts classifications, such as those provided in accounts classification options 1612.

If display screen 1600 is displaying top scored objects based on the selection of accounts option 1610, or any one of accounts classification options 1612, contact listing 1620 may still include contacts and may follow the same principles provided above. Alternatively, contacts listing 1620 may include all accounts that match the object of object listing 1618. Each of the accounts listed may include hyperlinks or other selectable options with the account name to access the account's profile, to provide a list of contacts associated with the contact, or to provide any means of contacting contacts of the account to inform them of the object (e.g., e-mail, phone, etc.). Accounts listed in listing 1620 may be listed in order of account priority or classification or any other manner provided above.

Display screen 1600 may also include pending calls option 1622. Pending calls option 1622 may provide a list of the top scored objects for contacts or contacts at accounts the user intended on contacting shortly. Contacts or contacts at accounts the user intended on contacting may be inputted in a separate display screen, maintained by a separate organizer software application, or maintained in any desirable manner. The objects may be grouped in order of the time a user may desire to contact individual contacts. For example, individuals the user intends to contact today may be provided in one grouping of top scored objects, whereas individuals the user intends to contact tomorrow may be provided in another grouping of top scored objects. Any other grouping by time may also be provided.

Display screens of the CRM application as shown in FIGS. 3-9 and 14-16 use commonly-used application selection objects such as hyperlinks, buttons, lists, dropdown boxes, and checkboxes. It will be understood that these selection objects are only illustrative, and other selection objects can be used by those skilled in the art without departing from the scope and spirit of the present invention.

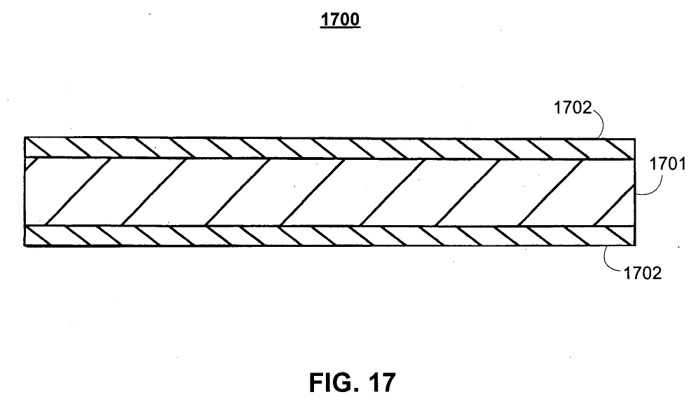

FIG. 17 presents a cross-section of a magnetic data storage medium 1700 which can be encoded with a machine executable program that can be carried out by equipment, such as any one or more of user equipment 107, information source 116, search engine 118, information source 120, client equipment 122, PBX 110, telephone system 112, and network 114 to implement methods discussed in connection with FIGS. 1-16. Medium 1700 may be a storage device of any one or more of user equipment 107, information source 116, search engine 118, information source 120, client equipment 122, PBX 110, telephone system 112, and network 114 of FIG. 1. Medium 1700 can be a floppy diskette or hard disk, having a suitable substrate 1701, which may be conventional, and a suitable coating 1702, which may be conventional, on one or both sides, containing magnetic domains (not visible) whose polarity or orientation can be altered magnetically. Medium 1700 may also have an opening (not shown) for receiving the spindle of a disk drive or other data device used to access the data stored on medium 1700.

The magnetic domains of coating 1702 of medium 1700 are polarized or oriented so as to encode, in manner which may be conventional, a machine-executable program such as those described above in connection with FIGS. 1-16 for execution by equipment such as any one or more of user equipment 107, information source 116, search engine 118, information source 120, client equipment 122, PBX 110, telephone system 112, and network 114 of FIG. 1.

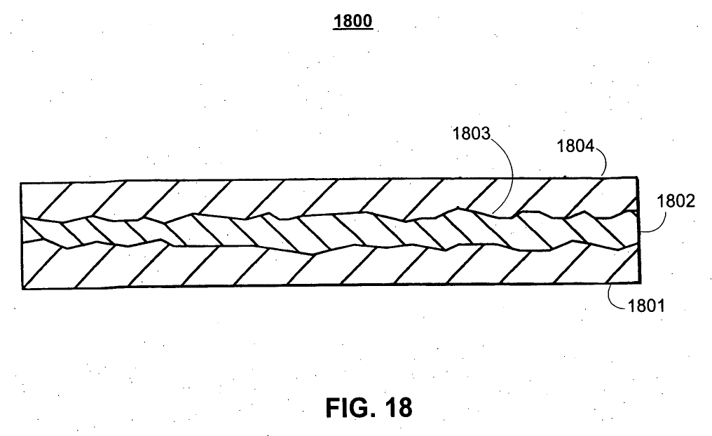

FIG. 18 shows a cross-section of an optically-readable data storage medium 1800 which also can be encoded with such a machine-executable program, which can be carried out by equipment such as any one or more of user equipment 107, information source 116, search engine 118, information source 120, client equipment 122, PBX 110, telephone system 112, and network 114 of FIG. 1. Medium 1800 can be a conventional compact disk read only memory (CD-ROM) or digital video disk read only memory (DVD-ROM) or a rewritable medium such as a CD-R or CD-RW, DVD-R, DVD-RW or DVD-RAM or a magneto-optical disk which is optically readable and magneto-optically rewritable. Medium 1800 preferably has a suitable substrate 1801, which may be conventional, and a suitable coating 1802, which may be conventional, usually on one or both sides of substrate 1801.

In the case of a CD-based or DVD-based medium, as is well-known, coating 1802 is reflective and is impressed with a plurality of pits 1803, arranged on one or more layers, to encode the machine-executable program. The arrangement of pits is read by reflecting laser light off the surface of coating 1802. A protective coating 1804, which preferably is substantially transparent, is provided on top of coating 1802.

In the case of a magneto-optical disk, as is well-known, coating 1802 has no pits 1803, but has a plurality of magnetic domains whose polarity or orientation can be changed magnetically when heated above a certain temperature, as by a laser (not shown). The orientation of the domains can be read by measuring the polarization of laser light reflected from coating 1802. The arrangement of the domains encodes the program as described above.

Thus, systems and methods for providing a enhanced contact relationship management application with a recommendation engine have been described. Persons skilled in the art will appreciate that the present invention can be practiced by other than the described embodiments, which are presented for purposes of illustration and not of limitation, and that the present invention is limited only by the claims which follow.

What is claimed is:

1. A method of providing a user with information that is of interest to at least one individual comprising:
storing in a database profile data for the at least one individual, wherein the profile data includes at least one keyphrase associated with the at least one individual;
searching in at least one external database for objects in which the at least one keyphrase is utilized;
identifying the objects in which the at least one keyphrase is utilized;
ranking the relevance of the identified objects using the profile data and ranking information, wherein the ranking information includes information for determining the relevance of the identified objects to the at least one individual; and
displaying to the user at least one list of the identified objects in which the at least one keyphrase is utilized, wherein the identified objects in the at least one list are displayed in the order in which the identified objects were ranked as relevant for the at least one individual.

2. The method of claim 1, wherein the at least one individual includes the user.

3. The method of claim 1, wherein the at least one individual includes at least one contact associated with the user.

4. The method of claim 1, wherein the at least one individual includes at least one account associated with the user.

5. The method of claim 1, wherein the ranking information includes information about at least one attribute of an object that is more relevant to the at least one individual than at least another attribute of the object.

6. The method of claim 5, wherein the at least one attribute and the at least another attribute each comprise an attribute category selected from the group consisting of an interest type, publication date, source type, advanced search, and an action taken upon an object, and wherein the at least one attribute and the at least another attribute are different attribute categories.

7. The method of claim 5, wherein the at least one attribute and the at least another attribute comprise an attribute category selected from the group consisting of interest type, publication date, source type, and an action taken upon an object, wherein the at least one attribute and the at least another attribute are the same attribute category, wherein the selected attribute category includes sub-categories, and wherein the at least one attribute and the at least another attribute are different sub-categories of the at least one attribute category.

8. The method of claim 7, wherein the selected attribute category comprises interest type, and wherein the at least one attribute and the at least another attribute each comprise a sub-category of interest type selected from group consisting of personal interests, professional interests, news interests, industry interests, and competitor interests.

9. The method of claim 7, wherein the selected attribute category comprises source type, and wherein the at least one attribute and the at least another attribute each comprise a sub-category of source type selected from the group consisting of web-based sources, text-based sources, portable document format files, video files, audio files, streaming video or audio broadcasts, television broadcasts, radio broadcasts, and telephone conferences.

10. The method of claim 7, wherein the selected attribute category comprises the action taken upon the object, and wherein the at least one attribute and the at least another attribute each comprise a sub-category of the action taken upon the object selected from the group consisting of the user clicking on the object, the user printing the object, the user e-mailing the object, the user saving the object, the user contacting the at least one individual by telephone about the object, and the at least one individual viewing the object.

11. The method of claim 1, wherein the ranking information includes scores assigned to attributes of objects.

12. The method of claim 1, wherein the ranking information includes a score assigned to a first attribute of objects that is greater than a score assigned to a second attribute of objects indicating that the first attribute is more relevant to the at least one individual than the second attribute.

13. The method of claim 1, further comprising providing the user with an opportunity to input that at least one keyphrase is more relevant to the at least one individual than at least another keyphrase, and wherein the profile data includes the information inputted by the user.

14. The method of claim 1, wherein the displaying further comprises displaying to the user at least two lists of the identified objects in which the at least one keyphrase is utilized, wherein the identified objects in each of the at least two lists are displayed in the order in which the identified objects were ranked as relevant for the at least one individual, and wherein each of the at least two lists are associated with a category of keyphrases.

15. The method of claim 1, wherein the displaying further comprises displaying to the user a list of identified objects in which a plurality of keyphrases are utilized, wherein the plurality of keyphrases are associated with a plurality of individuals, wherein the identified objects are displayed in the list in the order in which the identified objects were ranked.

16. The method of claim 15 further comprising displaying at least one individual with at least one of the identified objects in the displayed list, wherein the at least one individual is associated with the at least one of the identified objects based on the at least one keyphrase stored in the profile data.

17. The method of claim 15, wherein the list includes a predetermined number of the highest ranked objects.

18. The method of claim 15, wherein the plurality of individuals includes individuals the user intend on contacting within a specified time period.

19. A system for providing a user with information that is of interest to at least one individual, the system comprising:
a computing device;
a display device;
a database;
at least one external database; and
a software application implemented at least partially on the computing device configured to:
store in the database profile data for the at least one individual, wherein the profile data includes at least one keyphrase associated with the at least one of individual;
search in the at least one external database for objects in which the at least one keyphrase is utilized;
identify the objects in which the at least one keyphrase is utilized;
rank the relevance of the identified objects using the profile data and ranking information, wherein the ranking information includes information for determining the relevance of the identified objects to the at least one individual; and
display to the user on the display device at least one list of the identified objects in which the at least one keyphrase is utilized, wherein the identified objects in the at least one list are displayed in the order in which the identified objects were ranked as relevant for the at least one individual.

20. The system of claim 19, wherein the at least one individual includes the user.

21. The system of claim 19, wherein the at least one individual includes at least one contact associated with the user.

22. The system of claim 19, wherein the at least one individual includes at least one account associated with the user.

23. The system of claim 19, wherein the ranking information includes information about at least one attribute of an object that is more relevant to the at least one individual than at least another attribute of the object.

24. The system of claim 23, wherein the at least one attribute and the at least another attribute each comprise an attribute category selected from the group consisting of an interest type, publication date, source type, advanced search, and an action taken upon an object, and wherein the at least one attribute and the at least another attribute are different attribute categories.

25. The system of claim 23, wherein the at least one attribute and the at least another attribute comprise an attribute category selected from the group consisting of interest type, publication date, source type, and an action taken upon an object, wherein the at least one attribute and the at least another attribute are the same attribute category, wherein the selected attribute category includes sub-categories, and wherein the at least one attribute and the at least another attribute are different sub-categories of the at least one attribute category.

26. The system of claim 25, wherein the selected attribute category comprises interest type, and wherein the at least one attribute and the at least another attribute each comprise a sub-category of interest type selected from group consisting of personal interests, professional interests, news interests, industry interests, and competitor interests.

27. The system of claim 25, wherein the selected attribute category comprises source type, and wherein the at least one attribute and the at least another attribute each comprise a sub-category of source type selected from the group consisting of web-based sources, text-based sources, portable document format files, video files, audio files, streaming video or audio broadcasts, television broadcasts, radio broadcasts, and telephone conferences.

28. The system of claim 25, wherein the selected attribute category comprises the action taken upon the object, and wherein the at least one attribute and the at least another attribute each comprise a sub-category of the action taken upon the object selected from the group consisting of the user clicking on the object, the user printing the object, the user e-mailing the object, the user saving the object, the user contacting the at least one individual by telephone about the object, and the at least one individual viewing the object.

29. The system of claim 19, wherein the ranking information includes scores assigned to attributes of objects.

30. The system of claim 19, wherein the ranking information includes a score assigned to a first attribute of objects that is greater than a score assigned to a second attribute of objects indicating that the first attribute is more relevant to the at least one individual than the second attribute.

31. The system of claim 19, wherein the software application is further configured to provide the user with an opportunity to input that at least one keyphrase is more relevant to the at least one individual than at least another keyphrase, and wherein the profile data includes the information inputted by the user.

32. The system of claim 19, wherein the software application is further configured to display to the user on the display device at least two lists of the identified objects in which the at least one keyphrase is utilized, wherein the identified objects in each of the at least two lists are displayed in the order in which the identified objects were ranked as relevant for the at least one individual, and wherein each of the at least two lists are associated with a category of keyphrases.

33. The system of claim 19, wherein the software application is further configured to display to the user on the display device a list of identified objects in which a plurality of keyphrases are utilized, wherein the plurality of keyphrases are associated with a plurality of individuals, wherein the identified objects are displayed in the list in the order in which the identified objects were ranked.

34. The system of claim 33, the software application is further configured to display at least one individual with at least one of the identified objects in the displayed list, wherein the at least one individual is associated with the at least one of the identified objects based on the at least one keyphrase stored in the profile data.

35. The system of claim 33, wherein the list includes a predetermined number of the highest ranked objects.

36. The system of claim 33, wherein the plurality of individuals includes individuals the user intend on contacting within a specified time period.

37. Machine-readable media for providing a user with information that is of interest to at least one individual, the machine-readable media comprising machine-readable instructions recorded thereon for:
storing in a database profile data for the at least one individual, wherein the profile data includes at least one keyphrase associated with the at least one of individual;
searching in at least one external database for objects in which the at least one keyphrase is utilized;
identifying the objects in which the at least one keyphrase is utilized;
ranking the relevance of the identified objects using the profile data and ranking information, wherein the ranking information includes information for determining the relevance of the identified objects to the at least one individual; and
displaying to the user at least one list of the identified objects in which the at least one keyphrase is utilized, wherein the identified objects in the at least one list are displayed in the order in which the identified objects were ranked as relevant for the at least one individual.

38. The machine-readable media of claim 37, wherein the at least one individual includes the user.

39. The machine-readable media of claim 37, wherein the at least one individual includes at least one contact associated with the user.

40. The machine-readable media of claim 37, wherein the at least one individual includes at least one account associated with the user.

41. The machine-readable media of claim 37, wherein the ranking information includes information about at least one attribute of an object that is more relevant to the at least one individual than at least another attribute of the object.

42. The machine-readable media of claim 41, wherein the at least one attribute and the at least another attribute each comprise an attribute category selected from the group consisting of an interest type, publication date, source type, advanced search, and an action taken upon an object, and wherein the at least one attribute and the at least another attribute are different attribute categories.

43. The machine-readable media of claim 41, wherein the at least one attribute and the at least another attribute comprise an attribute category selected from the group consisting of interest type, publication date, source type, and an action taken upon an object, wherein the at least one attribute and the at least another attribute are the same attribute category, wherein the selected attribute category includes sub-categories, and wherein the at least one attribute and the at least another attribute are different sub-categories of the at least one attribute category.

44. The machine-readable media of claim 43, wherein the selected attribute category comprises interest type, and wherein the at least one attribute and the at least another attribute each comprise a sub-category of interest type selected from group consisting of personal interests, professional interests, news interests, industry interests, and competitor interests.

45. The machine-readable media of claim 43, wherein the selected attribute category comprises source type, and wherein the at least one attribute and the at least another attribute each comprise a sub-category of source type selected from the group consisting of web-based sources, text-based sources, portable document format files, video files, audio files, streaming video or audio broadcasts, television broadcasts, radio broadcasts, and telephone conferences.

46. The machine-readable media of claim 43, wherein the selected attribute category comprises the action taken upon the object, and wherein the at least one attribute and the at least another attribute each comprise a sub-category of the action taken upon the object selected from the group consisting of the user clicking on the object, the user printing the object, the user e-mailing the object, the user saving the object, the user contacting the at least one individual by telephone about the object, and the at least one individual viewing the object.

47. The machine-readable media of claim 37, wherein the ranking information includes scores assigned to attributes of objects.

48. The machine-readable media of claim 37, wherein the ranking information includes a score assigned to a first attribute of objects that is greater than a score assigned to a second attribute of objects indicating that the first attribute is more relevant to the at least one individual than the second attribute.

49. The machine-readable media of claim 37, further comprising machine-readable instructions recorded thereon for providing the user with an opportunity to input that at least one keyphrase is more relevant to the at least one individual than at least another keyphrase, and wherein the profile data includes the information inputted by the user.

50. The machine-readable media of claim 37 further comprising machine-readable instructions recorded thereon for displaying to the user at least two lists of the identified objects in which the at least one keyphrase is utilized, wherein the identified objects in each of the at least two lists are displayed in the order in which the identified objects were ranked as relevant for the at least one individual, and wherein each of the at least two lists are associated with a category of keyphrases.

51. The machine-readable media of claim 37 further comprising machine-readable instructions recorded thereon for displaying to the user a list of identified objects in which a plurality of keyphrases are utilized, wherein the plurality of keyphrases are associated with a plurality of individuals, wherein the identified objects are displayed in the list in the order in which the identified objects were ranked.

52. The machine-readable media of claim 51 further comprising machine-readable instructions recorded thereon for displaying at least one individual with at least one of the identified objects in the displayed list, wherein the at least one individual is associated with the at least one of the identified objects based on the at least one keyphrase stored in the profile data.

53. The machine-readable media of claim 51, wherein the list includes a predetermined number of the highest ranked objects.

54. The machine-readable media of claim 51, wherein the plurality of individuals includes individuals the user intend on contacting within a specified time period.
